(19) United States
(12) Patent Application Publication
(10) Pub. No.: US 2011/0208916 A1
(43) Pub. Date: Aug. 25, 2011

(54) SHARED CACHE CONTROLLER, SHARED CACHE CONTROL METHOD AND INTEGRATED CIRCUIT

(76) Inventor: Masahiko Saito, Kanagawa (JP)

(21) Appl. No.: 12/530,040

(22) PCT Filed: Nov. 28, 2008
(86) PCT No.: PCT/JP2008/003515

§ 371 Date: Sep. 4, 2009

(30) Foreign Application Priority Data
Dec. 10, 2007 (JP) 2007-318134

(51) Int. Cl. G06F 12/08

(52) U.S. Cl. 711/130; 711/E12.022; 711/E12.038

(57) ABSTRACT

A monitoring section 139 monitors a power control command for controlling power supplied to a processor for operating a plurality of operating systems or a plurality of processors. A cache entry selecting section 141 sets a cache entry used by the operating system or the processor having executed the power control command to a state used in the past using executed states of the plurality of operating systems or the plurality of processors that are changed based on the power control command upon selecting a cache entry to be replaced from a plurality of cache entries constituting a cache storage device 111. A replacement object selecting section 136 selects the cache entry set to the state used in the past as the cache entry to be replaced. In this way, the plurality of operating systems or the plurality of processors can effectively utilize one cache storage device.

### BACKGROUND OF THE INVENTION

1. Field of the Invention

The present invention relates to a shared cache controller, a shared cache control method and an integrated circuit for effectively utilizing a cache entry of a cache storage device shared by a plurality of operating systems or a plurality of processors.

2. Description of the Background Art

As a technological trend of system LSIs of recent years, multi-core architectures equipped with a plurality of processor cores have become popular. Particularly, in embedded system LSIs, there are cases where it is more advantageous to install a plurality of processor cores of middle or smaller sizes than to install one ultra-high speed processor core in terms of cost and power consumption. In recent years, hierarchical cache storage devices have been about to be introduced even into such embedded system LSIs. However, means for maintaining data coherency (consistency) between cache storage devices installed in individual processor cores is very cumbersome. Thus, in the embedded system LSI, a second level cache storage device is frequently shared among a plurality of processors even in the case of installing a first level cache storage device in each processor.

Particularly, mobile embedded computer systems represented by mobile phones and mobile terminals have come to possess remarkably high performance and, as described above, multi-core architectures equipped with a plurality of processor cores and virtual machine environments for operating a plurality of operating systems using a high-performance processor have been completed also in the embedded system LSIs.

With higher performance of processor cores themselves, many computer systems for operating a plurality of operating systems on one processor have been and are being used. In the virtual machine system, one cache storage device is shared by the plurality of operating systems independently of the introduction of the above hierarchical cache storage device.

In a computer system sharing a cache storage device in this way, there has been a possibility that data of individual operating systems or operating systems installed in individual processors throw data of other operating systems or operating systems installed in other processors out of the cache storage device.

As a method for solving this problem, a method for dividing a cache storage device into regions of an arbitrary size and allotting these regions to individual operating systems has been disclosed, for example, in patent literature 1. This enables one cache storage device to be effectively utilized by a plurality of operating systems without the individual operating systems (programs) throwing data of other operating systems out of the cache storage device.

However, in the above prior art, it is necessary to allot the usable regions of the cache storage device to the individual operating systems beforehand. Thus, there is a problem that, even if a certain operating system enters a sleep state or the like, the region in the cache storage device utilized by this operating system cannot be effectively utilized by the other operating systems. In other words, depending on execution states of the operating systems such as a low power consumption mode and a sleep mode, the allotted regions are not utilized and wasted.

### [Patent Literature 1]

Japanese Unexamined Patent Publication No. 2004-178571

### DISCLOSURE OF THE INVENTION

In order to solve the above problem, an object of the present invention is to provide a shared cache controller, a shared cache control method and an integrated circuit enabling one cache storage device to be effectively utilized by a plurality of operating systems or a plurality of processors.

One aspect of the present invention is directed to a shared cache controller, comprising a main storage; a cache storage device shared by a plurality of operating systems or a plurality of processors and including a plurality of cache entries for storing data read from the main storage; a monitoring section for monitoring a power control command for controlling power supplied to a processor operating the plurality of operating systems or the plurality of processors; a cache entry setting section for setting the cache entry used by the operating system or the processor having executed the power control command to a state used in the past using executed states of the plurality of operating systems or the plurality of processors that are changed based on the power control command when the cache entry to be replaced is selected from the plurality of cache entries; and a replacement object selecting section for selecting the cache entry set to the state used in the past by the cache entry setting section as the cache entry to be replaced.

Another aspect of the present invention is directed to a shared cache control method, comprising a cache storage step of storing data in a cache storage device which is shared by a plurality of operating systems or a plurality of processors and includes a plurality of cache entries for storing data read from a main storage; a monitoring step of monitoring a power control command for controlling power supplied to a processor operating the plurality of operating systems or the plurality of processors; a cache entry setting step of setting the cache entry used by the operating system or the processor having executed the power control command to a state used in the past using executed states of the plurality of operating systems or the plurality of processors that are changed based on the power control command when the cache entry to be replaced is selected from the plurality of cache entries; and a replacement object selecting step of selecting the cache entry set to the state used in the past in the cache entry setting step as the cache entry to be replaced.

Still another aspect of the present invention is directed to an integrated circuit, comprising a cache storage device shared by a plurality of operating systems or a plurality of processors and including a plurality of cache entries for storing data read from a main storage; a monitoring circuit for monitoring a power control command for controlling power supplied to a processor operating the plurality of operating systems or the plurality of processors; a cache entry setting circuit for setting the cache entry used by the operating system or the processor having executed the power control command to a state used in the past using executed states of the plurality of operating systems or the plurality of processors that are changed based on the power control command when the cache entry to be replaced is selected from the plurality of cache entries; and a replacement object selecting circuit for selecting the cache entry set to the state used in the past by the cache entry setting circuit as the cache entry to be replaced.

According to these constructions, the cache storage device is shared by the plurality of operating systems or the plurality of processors and includes the plurality of cache entries for storing the data read from the main storage. The power control command for controlling the power supplied to the processor operating the plurality of operating systems or the plurality of processors is monitored. Upon selecting the cache entry to be replaced out of the plurality of cache entries, the cache entry used by the operating system or processor having executed the power control command is set to the state used in the past using the executed states of the plurality of operating systems or the plurality of processors that are changed based on the power control command when the cache entry to be replaced is selected from the plurality of cache entries. Thereafter, the cache entry set to the state used in the past is selected as the cache entry to be replaced.

According to the present invention, it becomes possible to preferentially use the cache entry in the cache storage device, which is no longer used by one operating system or one processor due to a change of the executed state, by another operating system or another processor in the case where the cache storage device is shared by the plurality of operating systems or the plurality of processors. Therefore, the plurality of operating systems or the plurality of processors can effectively utilize the cache storage device.

The objects, features, aspects and advantages of the present invention will become more apparent upon the reading of the following detailed description and accompanying drawings.

### BRIEF DESCRIPTION OF THE DRAWINGS

FIG. 1 is a diagram showing the construction of a computer system according to a first embodiment of the invention,

FIG. 2 is a diagram showing a cache storage device using a four-way set associative method,

FIG. 3 is a diagram showing a detailed construction of the cache storage device relating to a cache entry selection process in the first embodiment of the invention,

FIG. 4 is a diagram showing a detailed construction of the cache storage device relating to a cache entry replacement process in the first embodiment of the invention,

FIG. 5 is a diagram showing possible values of reference time data in the first embodiment of the invention,

FIG. 6 is a diagram showing the construction of a computer system according to a second embodiment of the invention,

FIG. 7 is a diagram showing a detailed construction of a level 2 cache storage device relating to a cache entry selection process in the second embodiment of the invention,

FIG. 8 is a diagram showing a detailed construction of the level 2 cache storage device relating to a cache entry replacement process in the second embodiment of the invention,

FIG. 9 is a diagram showing the construction of a computer system according to a third embodiment of the invention,

FIG. 10 is a flow chart showing the operation of a lock down controlling section shown in FIG. 9,

FIG. 11 is a diagram showing the construction of a computer system according to a fourth embodiment of the invention,

FIG. 12 is a diagram showing a detailed construction of a cache storage device relating to a cache entry selection process in the fourth embodiment of the invention,

FIG. 13 is a table showing possible values of reference counter bits of reference time data in the fourth embodiment of the invention,

FIG. 14 is a diagram showing the construction of a computer system according to a fifth embodiment of the invention,

FIG. 15 is a diagram showing a detailed construction of a level 2 cache storage device relating to a cache entry replacement process in the fifth embodiment of the invention, and

FIG. 16 is a diagram showing the construction of a computer system according to a sixth embodiment of the invention.

### BEST MODES FOR EMBODYING THE INVENTION

Hereinafter, embodiments of the present invention are described with reference to the drawings. It should be noted that the following embodiments are specific examples of the present invention and not of the nature to limit the technical scope of the present invention.

### First Embodiment

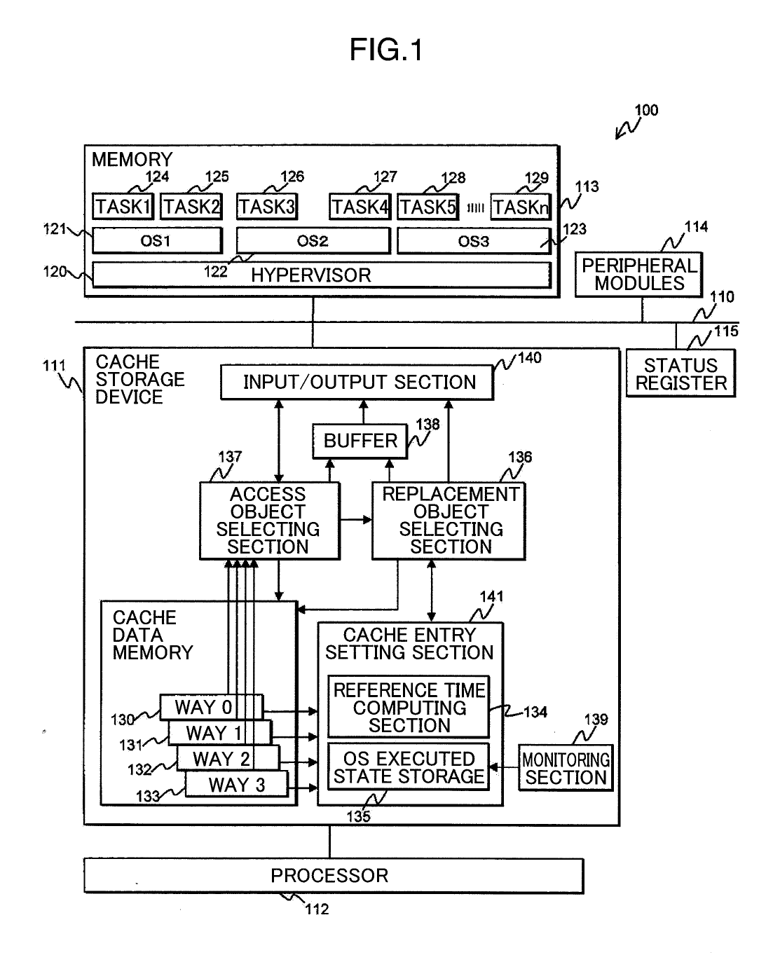

FIG. 1 is a diagram showing the construction of a computer system according to a first embodiment of the present invention. A computer system 100 is a virtual machine system for operating a plurality of operating systems on one processor. The computer system 100 is provided with an internal bus 110, a cache storage device 111, a processor 112, a memory 113, peripheral modules 114 and a status register 115.

The cache storage device 111, the memory 113, the peripheral modules 114 and the status register 115 are respectively connected with the internal bus 110. With high integration of LSIs of recent years, it is also possible to mount a plurality of circuits constituting the computer system 100 on one system LSI, but no limitation is made as to whether circuits are mounted on a single system LSI or mounted on different system LSIs in this first embodiment. Although the status register 115 is connected with the internal bus 110 in FIG. 1, it may be directly connected with the processor 112.

The processor 112 reads a program (command codes) stored in the memory 113 and executes it. Upon executing the program, the processor 112 operates while referring to data on the memory 113 and input/output data from the peripheral modules 114. The processor 112 also executes a control using values of state parameters during the operation held by the status register 115.

The memory includes first to n-th tasks 124 to 129, first to third operating systems 121, 122 and 123 and a hypervisor 120.

The first to n-th task 124 to 129 are executable units each including a single or a plurality of command codes that respectively operate on the computer system 100 and, for example, application programs executed by the processor 112.

The first to third operating systems 121, 122 and 123 are operating systems for controlling the entire software operating on the computer system 100. Here, the memory 113 includes three operating systems 121, 122 and 123.

The hypervisor 120 operates on the processor 112 and is emulation means for providing such an environment where the first to third operating systems 121, 122 and 123 are operating as if like a single operating system, i.e. a virtual machine environment. In other words, instead of one operating system present on one processor and managing a plurality of hardware resources of this processor, a plurality of hardware resources can be divided and allotted to the individual operating systems by the hypervisor 120. A method for fixedly allotting depending on the types of the hardware resources and a method for allotting in a time sharing manner can be used as an allotting method.

As an example of the computer system of the first embodiment, it is assumed to be compiled such that the first and second tasks 124, 125 operate on the first operating system 121, the third and fourth tasks 126, 127 operate on the second operating system 122 and the fifth to n-th tasks 128, 129 operate on the third operating system 123 in FIG. 1. Thus, the first operating system 121 manages executed states of the first and second tasks 124, 125, the second operating system 122 manages executed states of the third and fourth tasks 126, 127 and the third operating system 123 manages executed states of the fifth to n-th tasks 128, 129.

Although the first, second and third operating systems 121, 122 and 123 are different operating systems here, they may be the same operating system. The number of the tasks, the number of the operating systems and the relationship of the tasks and the operating systems may not coincide with the example shown in FIG. 1. For example, it does not matter to change the number of operational operating systems.

The cache storage device 111 is a set associative cache storage device and includes cache data memories divided in a plurality of ways. Although cache data memories 130 to 133 divided in four ways are present in FIG. 1, it is also possible to install less than four ways or more than four ways. In the set associative cache storage device, as many selectable cache entries as the ways are present for one address.

Each of the cache data memories 130 to 133 is comprised of a plurality of cache entries for storing data read from the memory 113.

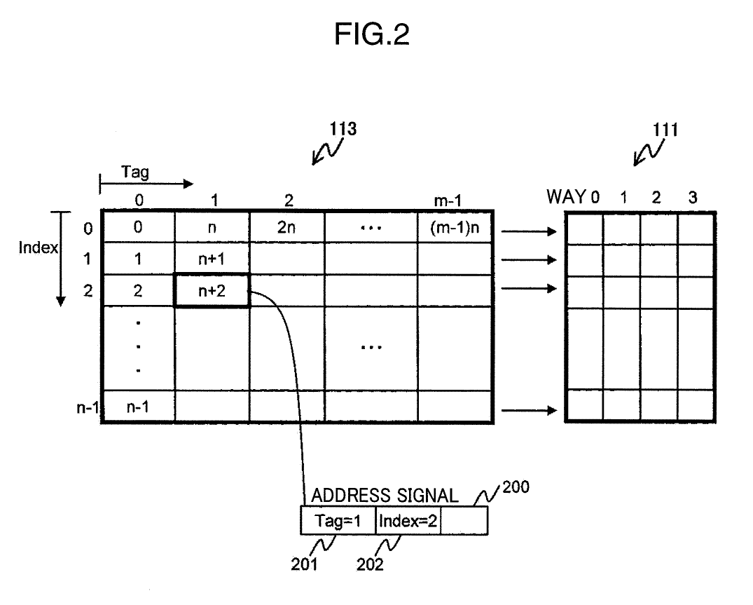

FIG. 2 is a diagram showing the four-way set associative cache storage device. Each address signal 200 indicating the position of data on the memory 113 includes an upper address tag 201 and an index number 202, and data on the memory 113 are divided into as many groups as tags by the address signals 200. One group of data on this memory 113 is stored in one way of the cache storage device. In other words, four groups of data are simultaneously stored in the cache storage device since the four ways are present here.

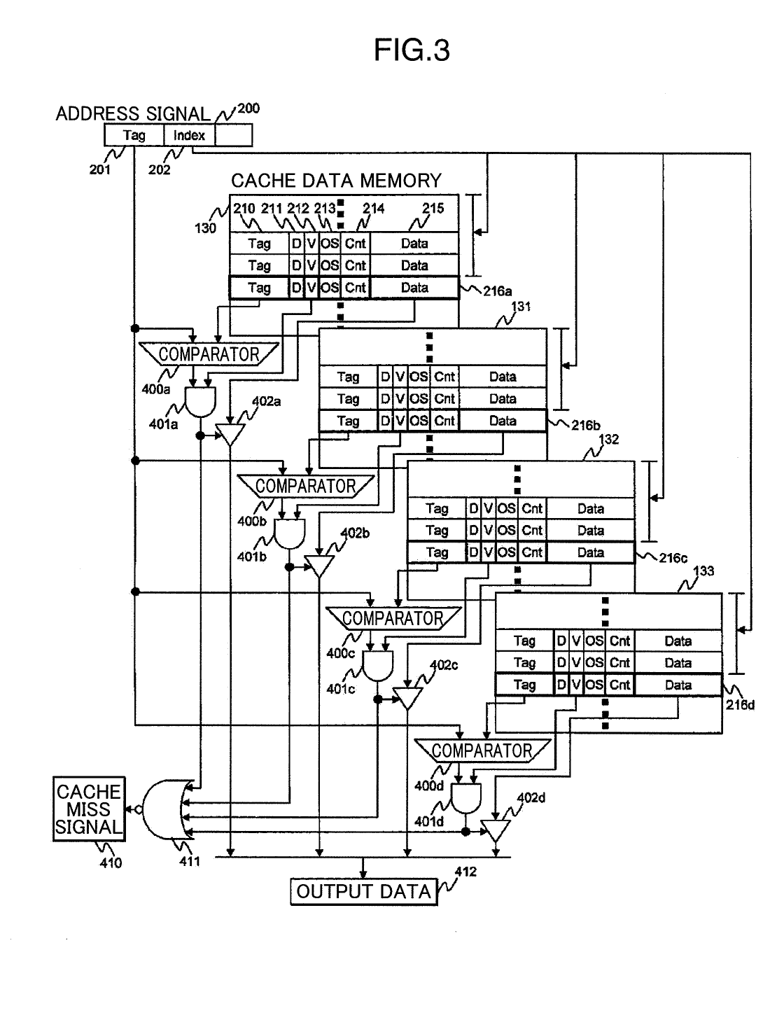

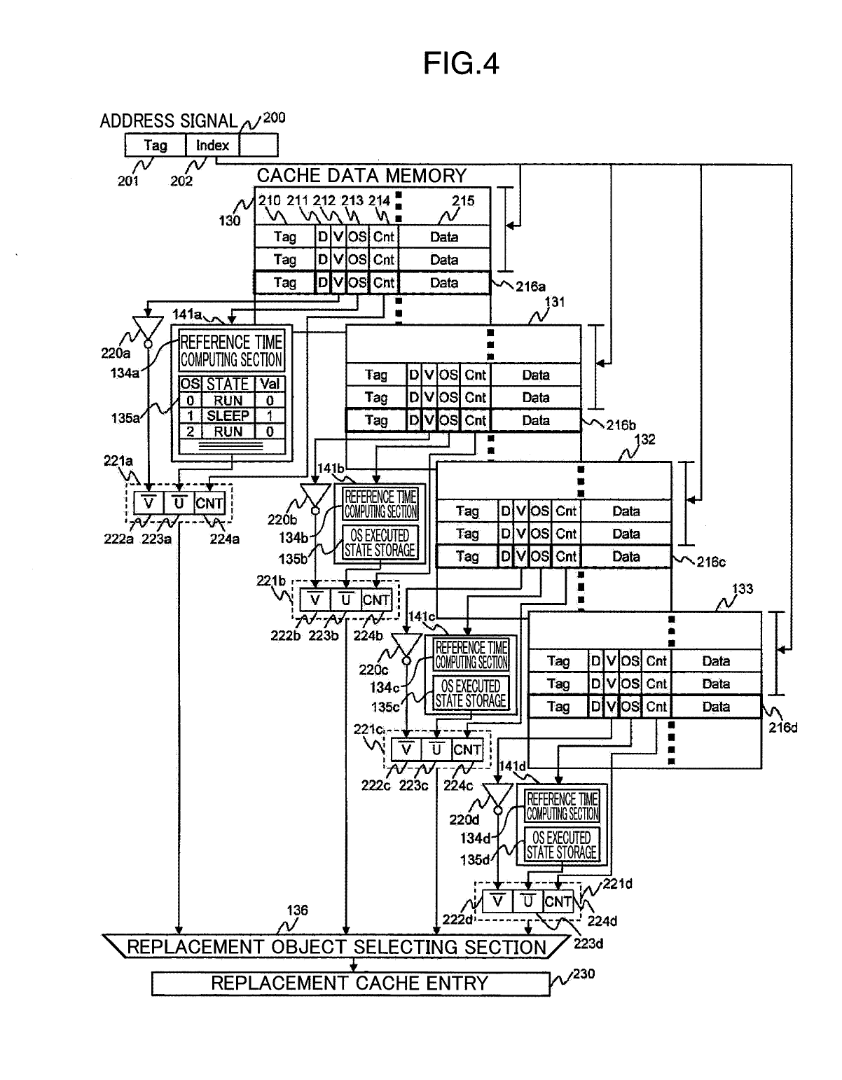

Although described later with reference to FIGS. 3 and 4, many comparators operating in parallel are normally present in the case of a large number of ways, which is disadvantageous in terms of power consumption. On the other hand, in the case of a small number of ways, there are less positions where data on one address can be stored and a phenomenon called thrashing (data stored in a plurality of addresses throw the others from the cache entries each other) occurs, thereby causing performance deterioration.

Further, if a cache miss occurs and data in a certain address is stored on the cache storage device, it is necessary to select any one of the cache entries and replace data. An LRU (Least Recently Used) algorithm assuming that recently accessed data have higher probabilities of being reused and least recently accessed data have lower probabilities of being reused is known as a replacement algorithm for most reducing cache misses. In the first embodiment, the cache storage device 111 replaces the cache entry using the LRU algorithm. Further, an operating system identifier indicating which operating system is using the cache entry is included in each individual cache entry. The operating system identifier is described with reference to FIG. 3.

The cache storage device 111 includes the cache data memories 130 to 133 described above, a replacement object selecting section 136, an access object selecting section 137, a buffer 138, a monitoring section 139, an input/output section 140 and a cache entry setting section 141.

The input/output section 140 is for inputting access commands to data on the memory 113 and the peripheral modules 114 such as data read-out commands and data write-in commands from the processor 112 and outputting data to the processor 112, the memory 113 and the peripheral modules 114 in response to access commands.

The monitoring section 139 monitors a power control command executed by the processor 112 by checking the status register 115 and notifies a state change of the operating system executing this power control command to a reference time computing section 134. The monitoring section 139 monitors the power control command for controlling power supplied to the processor 112 for operating a plurality of operating systems. The power control command includes a sleep command for instructing the operation stop of the operating system, a power supply control command for reducing power supplied to the processor 112 and a clock control command for reducing clocks supplied to the processor 112. In the first embodiment, the power control command includes at least the sleep command.

The first to third operating systems 121, 122 and 123 issue power control commands in the case of entering a sleep mode depending on the number of tasks operating on the individual operating systems and the states of the tasks, and the processor 112 executes the issued power control commands. Further, the processor 112 executes a processing of returning to a normal operation mode from the sleep mode when a processing load changes upon the occurrence of an interrupt or the like.

The cache entry setting section 141 sets the cache entry used by the operating system having executed the power control command to a state used in the past using the executed states of a plurality of operating systems that are changed based on the power control command when a cache miss occurs and the cache entry to be replaced is selected from a plurality of cache entries. In the first embodiment, the executed states include at least the normal operation mode in which the operating system is operated with a high speed clock and the sleep mode in which the operation of the operating system is stopped. The cache entry setting section 141 sets the cache entry used by the operating system in the sleep mode to the state used in the past by the cache entry used by the operating system in the normal operation mode.

The cache entry setting section 141 includes the reference time computing section 134 and an OS executed state storage 135.

The reference time computing section 134 receives notification from the monitoring section 139 and manages the operation mode of the operating system executing the power control command using the OS executed state storage 135. The OS executed state storage 135 holds the operating system identifiers for identifying the operating systems and the executed states of the respective operating systems (normal operation mode or sleep mode) in the form of a table.

Although the OS executed state storage 135 holds the operation modes of the operating systems in the form of the table here, the operation modes of the operating systems may be stored in another format.

The reference time computing section 134 computes reference time data of a plurality of cache entries as candidates for a replacement object in response to an inquiry from the replacement object selecting section 136 and notifies the computed reference time data to the replacement object selecting section 136. The reference time data are data used to select the cache entry to be replaced. The reference time data are described in detail later.

The reference time computing section 134 outputs the reference time data of the cache entry used by the operating system in the sleep mode as a value used in the most distant past using the OS executed state storage 135, the operating system identifiers provided for the individual cache entries and a reference time counter to be described later. The cache storage device 111 operates with a normal LRU algorithm if there is no operating system in the sleep mode.

The replacement object selecting section 136 selects the cache entry set in the state used in the past by the cache entry selecting section 141 as the cache entry to be replaced. The replacement object selecting section 136 determines which one of data already stored on the cache storage device 111 to be thrown out and replaces the determined data by new data in the case of reading new data from the memory 113 and storing it in the cache storage device 111, for example, upon the occurrence of a cache miss. In other words, the replacement object selecting section 136 inquires for a plurality of cache entries as candidates for a replacement object to the reference time computing section 134 when the occurrence of a cache miss is notified from the access object selecting section 137. Thereafter, the replacement object selecting section 136 selects the cache entry to be replaced from the plurality of cache entries in accordance with the computation result outputted from the reference time computing section 134 and stores new data in the selected cache entry.

If there is data thrown out by replacing the cache entry, the thrown-out data needs to be written on the memory 113 again. In this case, the replacement object selecting section 136 writes data in the same way as the cache entry to be replaced in the buffer 138 and writes the data before replacement on the memory 113 again.

By the above construction, assuming that the data on the cache storage device 111 used by the operating system executed in the sleep mode as least recently used data, this data can be replaced by new data of the operating system in the normal operation mode. As a result, a control can be so executed that the data of the operating system in the normal operation mode preferentially remains in the cache storage device 111. In this way, the cache entry with a lower frequency of use by the transfer of the operating system to the sleep mode can be effectively used by another operating system, and the performance of the entire system can be improved.

The method of the first embodiment is not such a method enabling the cache entry to be used by another operating system by uniformly invalidating data used by the operating system having entered the sleep mode from the cache entry. Thus, the cache entry used in the past can be effectively used if necessary data remains to be stored in the cache when the operating system having entered the sleep mode returns to the normal operation mode again.

In the first embodiment, the computer system 100 corresponds to an example of a shared cache controller, the memory 113 to an example of a main storage, the cache storage device 111 to an example of a cache storage device, the monitoring section 139 to an example of a monitoring section, the cache entry selecting section 141 to an example of a cache entry selecting section, the replacement object selecting section 136 to an example of a replacement object selecting section, the OS executed state storage 135 to an example of an executed state storage, and the reference time computing section 134 to an example of a reference time data generating section.

FIG. 3 is a diagram showing a detailed construction of the cache storage device relating to a cache entry selection process when the processor 112 accesses the cache storage device 111 in response to a memory access command outputted from the processor 112 or the like. In FIG. 3, the cache data memories 130 to 133 are hardware components similar to those of FIG. 1.

As described above, the address signal 200 indicating data to be accessed includes the index number 202 indicating an offset in the cache data memory 130 to 133 and the upper address tag 201 other than the index number 202. In each of the individual cache data memories 130 to 133, the cache entry located at the offset designated by the index number 202 is an accessible cache entry. Cache hit detection is made among these four cache entries located at the offset designated by these index number 202.

Although only the four-way cache data memories 130 to 133 are shown for the sake of graphical representation in the first embodiment, the present invention is not particularly limited to this and the cache storage device 111 can be equipped with cache data memories of less than four ways or more than four ways and the number of the cache entries to be replaced increases or decreases with the number of the ways.

Each cache entry in each individual cache data memory is made up of fields including at least an upper address tag 210, a dirty bit 211, a valid bit 212, an operating system identifier 213, a reference time counter (reference time count value) 214 and cache data 215.

The upper address tag 210 is a field storing an upper address excluding an index number concerning an address of data stored in this cache entry. The dirty bit 211 is a field indicating whether or not any data has been rewritten on the cache storage device 111. If the dirty bit 211 is ON, the cache data 215 has to be finally written on the memory 113 again. If the dirty bit 211 is OFF, the cache data 215 needs not be written on the memory 113 again.

The valid bit 212 is a field indicating whether or not the cache entry is effective. The operating system identifier 213 is a field indicating which one of the operating systems is using the cache entry. If the individual operating system accesses the cache entry, the number for identifying this operating system is stored in this field.

The reference time counter 214 is a field indicating to which extent the data in this cache entry has been referred to in the past. For example, if the cache storage device 111 constitutes four-way cache data memories, a reference time counter of two bits is provided and the value of the reference time counter 214 is set to “0” every time access is made. Out of the four-way cache data memories, the values of the reference time counters 214 in the cache entries that were not selected are increased to indicate a series of values in a range up to “3”. Thus, the values of the reference time counters 214 are successively in the order of “3”, “2”, “1” and “0” from the least recently used cache entry. In the cache storage device using the LRU algorithm, the cache entry having a maximum value of the reference time counter 214 become a final replacement object. The cache data 215 is a field for temporarily storing data read from the memory 113.

As described above, the cache entry includes the operating system identifier 213 for identifying the operating system using this cache entry, the reference time counter (reference time count value) 214 that is counted according to time this cache entry is referred to and increases as the reference time becomes older and the cache data 215.

The cache entry selection process of selecting the cache entry to be accessed is described in detail with reference to FIG. 3.

First of all, in the case of accessing data in the cache storage device 111 in response to a memory access command or the like, the access object selecting section 137 receives address signals 200 via the input/output section 140 from the processor 112 and starts the cache entry selection process.

The access object selecting section 137 selects four cache entries in the cache data memories 130 to 133 using the index numbers 202 included in the address signals 200. Here, it is assumed that cache entries 216a to 216d are selected.

Next, comparators 400a to 400d compare the upper address tags 201 in the address signals 200 and the upper address tags 210 in the cache entries 216a to 216d.

If there exists any cache entry whose upper address tag 210 coincides with the upper address tag 201 in the address signal 200 and whose valid bit 212 is ON, it means that desired data is present in this cache entry. In FIG. 3, logical AND operators 401a to 401d detect a cache hit by computing AND operations of outputs from the comparators 400a to 400d and the valid bits 212 in the cache entries 216a to 216d.

The cache hit means that the data read in response to the memory access command is present in the cache storage device 111. The access object selecting section 137 detects the cache hit when the upper address tag 210 coincides with the upper address tag 201 in the address signal 200 and the valid bit 212 is ON. The logical AND operators 401a to 401d output control signals indicating the presence or absence of the cache hit to buffers 402a to 402d.

The logical AND operators 401a to 401d respectively control the outputs of the buffers 402a to 402d. The cache data 215 in the cache entries 216a to 216d are respectively inputted to the buffers 402a to 402d. The buffers 402a to 402d output the same values as the cache data 215 if the control signals from the logical AND operators 401a to 401d indicate the cache hit. On the other hand, the buffers 402a to 402d are in a high impedance state if the control signals indicate no cache hit. Out of the cache entries 216a to 216d, there is at most one entry to be actually cache hit. Thus, the input/output section 140 can obtain output data 412 when output signals of the buffers 402a to 402d are inputted thereto as they are.

Although not shown for the sake of graphical representation, the access object selecting section 137 sets the reference time counter 214 of the hit cache entry out of the cache entries 216a to 216d to “0” and sets the values of “1”, “2” and “3” again in the reference time counters 214 of the other cache entries in an increasing order of the values of the reference time counters 214. In this way, the values of the reference time counters 214 are arranged in the order of “3”, “2”, “1” and “0” from the least recently accessed cache entry as described above.

Further, the access object selecting section 137 can detect that none of the cache entries 216a to 216d is hit using a NOT-OR operator 411 to which all the outputs from the logical AND operators 401a to 401d are inputted. The NOT-OR operator 411 computes a cache miss signal 410 using the outputs from the logical AND operators 401a to 401d. In the case of a cache miss, the access object selecting section 137 sends the cache miss signal 410 to the replacement object selecting section 136, which in turn performs a cache entry replacement process.

FIG. 4 is a diagram showing a detailed construction of the cache storage device 111 relating to the cache entry replacement process in the case of a cache miss as a result of the cache entry selection process shown in FIG. 3. In FIG. 4, cache data memories 130 to 133 are hardware parts similar to those of FIG. 1. Further, reference time computing sections 134a to 134d correspond to the reference time computing section 134 shown in FIG. 1.

The cache entry replacement process for replacing data in the cache entry by new data is described in detail below with reference to FIG. 4.

First of all, when it is necessary to read new data from the memory 113 and store it in the cache storage device 111 due to a cache miss or the like, the replacement object selecting section 136 receives a cache miss signal 410 from the access object selecting section 137 and starts the cache entry replacement process.

The replacement object selecting section 136 selects four cache entries in the cache data memories 130 to 133 using the index numbers 202 included in the address signals 200. Here, it is assumed that the cache entries 216a to 216d were selected.

If a normal LRU algorithm is used as a method for selecting one cache entry out of these four cache entries 216a to 216d as a replacement object, the reference time counters 214 in the cache entries 216a to 216d are compared and the least recently referred cache entry, i.e. the one with a maximum value of the reference time counter 214 is selected. However, the method using the LRU algorithm handles data of the operating system in the normal operation mode and data of the operating system having entered the sleep mode immediately before in a same manner.

On the other hand, in the cache storage device 111 of the first embodiment, the monitoring section 139 monitors the power control command executed by the processor 112 and notifies the state change of the operating system executing this power control command to the reference time computing section 134 and the reference time computing section 134 manages the executed states of the respective operating systems. Thus, the cache entry used by the operating system entering the sleep mode can be set to the least recently used state and another operating system can effectively utilize the cache entry used by the operating system having entered the sleep mode.

Each of the first to third operating systems 121, 122 and 123 issues a power control command in the case of entering the sleep mode depending on the number and states of the tasks operated on the individual operating system. Each of the first to third operating systems 121, 122 and 123 returns from the sleep mode to the normal operation mode if a processing load changes upon the occurrence of an interrupt or the like.

The reference time computing sections 134a to 134d manage the operation modes of the individual operating systems using OS executed state storages 135a to 135d. Although the reference time computing sections 134a to 134d and the OS executed state storages 135a to 135d are provided in the individual cache entry setting sections 141a to 141d in the first embodiment, one reference time computing section 134 and one OS executed state storage 135 may be shared among the cache entry setting sections 141a to 141d. In this way, data coherency can be more efficiently ensured.

In FIG. 4, contents of a table of only the OS executed state storage 135a are shown in detail. In the table stored in the OS executed state storage 135a of FIG. 4, three operating systems exist. Operating system identifiers of the respective three operating systems are “0”, “1” and “2”. An executed state of the operating system identifier “0” is assumed to be the normal operation mode, that of the operating system identifier “1” to be the sleep mode and the operating system identifier “2” to be the normal operation mode.

In FIG. 4, the executed state of the operating system in the normal operation mode is expressed by “RUN” and that of the operating system in the sleep mode is expressed by “SLEEP”.

As an executed state value (Val) corresponding to the executed state of the operating system, the OS executed state storages 135a to 135d hold “0” in the case of the normal operation mode and “1” in the case of the sleep mode.

Next, the reference time computing sections 134a to 134d generate reference time data corresponding to the respective cache entries 216a to 216d using the reference time counters 214 in the selected cache entries 216a to 216d, the valid bits 212 in the selected cache entries 216a to 216d and the executed state values (Val) corresponding to the executed states of the operating systems in the OS executed state storages 135a to 135d.

Reference time data 221a corresponding to the cache entry 216a is made up of an invalid bit 222a obtained by reversing the valid bit 212 using a negation operator 220a, a state bit 223a using the executed state value (Val) corresponding to the executed state of the operating system stored in the OS executed state storage 135a and a reference counter bit 224a using the value of the reference time counter 214 as it is. Similarly, reference time data 221b to 221d corresponding to the cache entries 216b to 216d are made up of invalid bits 222b to 222d obtained by reversing the valid bits 212 of the respective cache entries using negation operators 220b to 220d, state bits 223b to 223d using the executed state values (Val) corresponding to the executed states of the operating systems stored in the OS executed state storage 135b to 135d and reference counter bits 224b to 224d using the values of the reference time counters 214 as they are.

The replacement object selecting section 136 receives and compares these reference time data 221a to 221d, selects the cache entry with a maximum numerical value of the reference time data as the replacement object, and outputs the selected cache entry as a replacement cache entry 230. Further, the replacement object selecting section 136 writes data in the same way as the cache entry to be replaced in the buffer 138 and writes data before the replacement on the memory 113 if there is any data thrown out by the replacement of the selected cache entry.

Specifically, if there is one cache entry whose valid bit 212 is OFF out of the selected cache entries 216a to 216d, the invalid bit 222a to 222d as the most valid bit in the reference time data 221a to 221d is ON. Therefore, the reference time data of this cache entry is largest.

Further, if all the cache entries 216a to 216d are effective, i.e. the valid bits 212 of all the cache entries 216a to 216d are ON, the invalid bits 222a to 222d as the most valid bits in the reference time data 221a to 221d are all “0”. At this time, if there is one cache entry used by the operating system in the sleep mode out of the selected cache entries 216a to 216d, the state bit 223a to 223d as the second most valid bit in the reference time data 221a to 221d is ON. Therefore, the reference time data of this cache entry is largest.

Further, if all the cache entries 216a to 216d are effective and used by the operating systems in the normal operation mode, the invalid bits 222a to 222d as the most valid bits and the state bits 223a to 223d as the second most valid bits are all “0”. At this time, the reference counter bits 224a to 224d corresponding to the values of the reference time counters 214 of the cache entries 216a to 216d are used as they are. Thus, out of the reference time data 221a to 221d, the value of the reference time data corresponding to the least recently referred cache entry is largest.

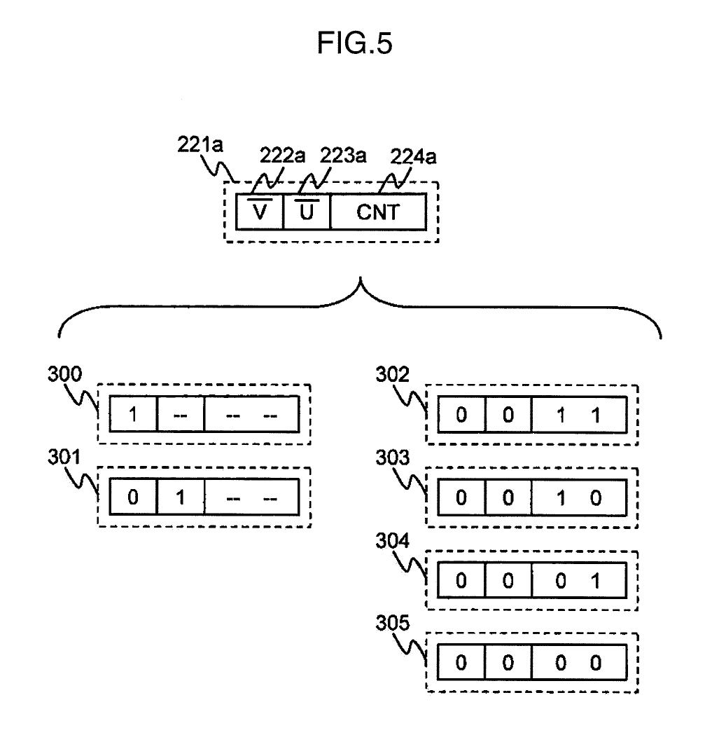

FIG. 5 is a diagram showing possible values of the reference time data 221a. The reference time data 300 is a value when the valid bit 212 is OFF. In this case, the value of the reference time data 300 is larger than any other reference time data 301 to 305 regardless of the values of the bits other than the invalid bit 222a.

The reference time data 301 is a value when the valid bit 212 is ON, but the cache entry is used by the operating system in the sleep mode. In this case, regardless of the value of the reference counter bit 224a, the value of the reference time data 301 is larger than the reference time data 302 to 305 of the cache entries used by the operating systems in the normal operation mode.

The reference time data 302 to 305 are values when the valid bits 212 are ON and the cache entries are used by the operating systems in the normal operation mode. The reference time data 302 to 305 are compared by the magnitudes of the values of the reference counter bits 224a. The reference counter bit 224a is expressed by two bits since the cache data memory has a four-way construction in the first embodiment.

In this way, the OS executed state storages 135a to 135d store the executed states of a plurality of operating systems that are changed in accordance with a power control command and executed state values that are set beforehand according to the executed states and are larger when corresponding to the sleep mode than when corresponding to the normal operation mode. Further, the reference time computing sections 134a to 134d generate the reference time data 221a to 221d including the executed state value and the reference time count value for each of a plurality of cache entries.

The replacement object selecting section 136 compares the reference time data 221a to 221d for the respective plurality of cache entries generated by the reference time computing sections 134 and selects the cache entry corresponding to the reference time data with the largest executed state value included in the reference time data as the cache entry to be replaced.

The replacement object selecting section 136 compares the reference time data 221a to 221d for the respective plurality of cache entries generated by the reference time computing sections 134 and selects the cache entry corresponding to the reference time data with the largest reference time count value included in the reference time data as the cache entry to be replaced when all the executed state values included in the reference time data are the same.

By this construction, the cache entry whose valid bit 212 is not ON and the cache entry used by the operating system in the sleep mode are prioritized as those to be replaced. Only when there is no such cache entry, the cache entry is replaced using the LRU algorithm. Thus, in the computer system in which a plurality of operating systems share the cache storage device, the cache entry no longer used by one operating system can be preferentially used by another operating system and the cache storage device of a limited size can be effectively utilized.

By the above, the cache entry that is not effective can be most prioritized as the replacement object and, then, the data of the cache entry used by the operating system executed in the sleep mode can be selected as the replacement object, assuming this data as data of the least recently used cache entry. In this way, a control can be executed such that the data of the operating system in the normal operation mode preferentially remains in the cache storage device 111.

The first embodiment does not relate to the method for uniformly invalidating data from the cache entry. Thus, the cache entry used in the past can be effectively used if the operating system having entered the sleep mode returns to the normal operation mode again due to the states of devices or the like. Since the value of the state bit returns to “0” in the case of return to the normal operation mode, the replacement object is selected using the LRU algorithm.

### Second Embodiment

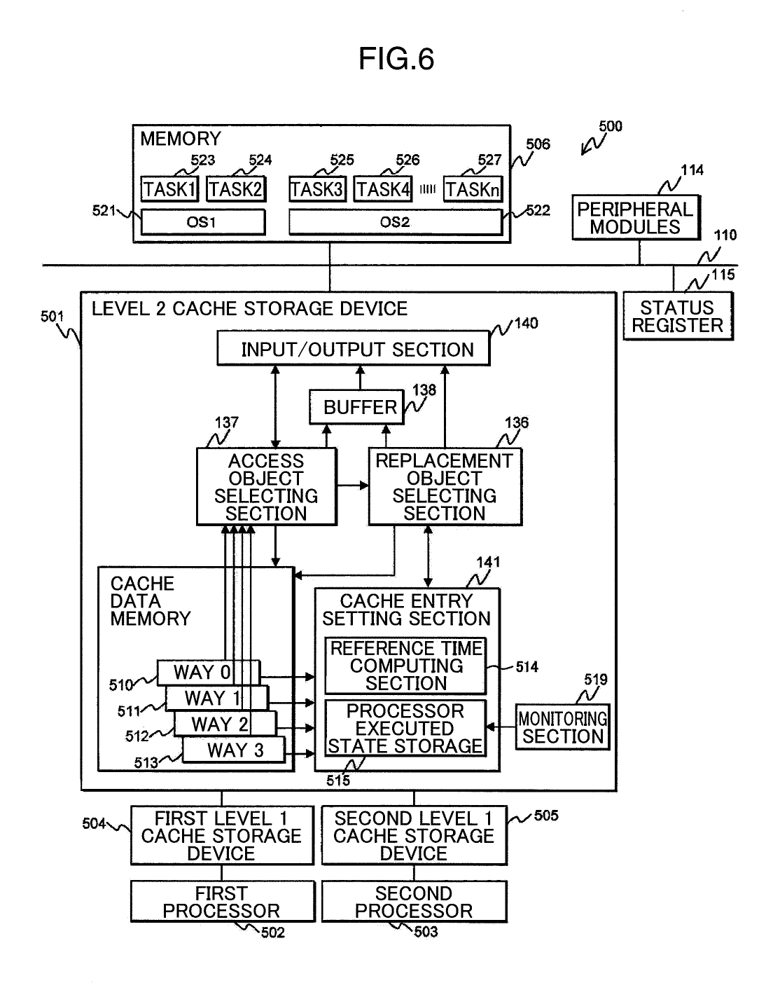

FIG. 6 is a diagram showing the construction of a computer system according to a second embodiment of the present invention. A computer system 500 is a multiprocessor system in which a plurality of processors share a memory and a cache storage device.

The computer system 500 is provided with an internal bus 110, peripheral modules 114, a status register 115, a plurality of processors (first processor 502 and second processor 503), a plurality of level 1 cache storage devices (first level 1 cache storage device 504 and second level 1 cache storage device 505), a level 2 cache storage device 501 and a memory 506. The internal bus 110, the peripheral modules 114 and the status register 115 are the same constituent elements as those described with reference to FIG. 1.

With high integration of LSIs of recent years, it is also possible to mount a plurality of circuits constituting the computer system 500 on one system LSI, but no limitation is made as to whether circuits are mounted on a single system LSI or mounted on different system LSIs in this second embodiment. Although only two processors are installed in the second embodiment, the number of the processors is not limited to two and three or more processors may coexist. Further, although the status register 115 is connected with the internal bus 110 as in FIG. 1, it may be directly connected with the first and second processors 502 and 503.

The first and second processors 502, 503 respectively read and execute a program (command codes) stored in the memory 506. The first and second processors 502, 503 operate while referring to data on the memory 506 and input/output data from the peripheral modules 114 at the time of executing the program. Further, the first and second processors 502, 503 execute controls using the values of state parameters during the operation held by the status register 115.

The memory 506 includes first to n-th tasks 523 to 527 and first and second operating systems 521, 522.

The first to n-th task 523 to 527 are executable units each including a single or a plurality of command codes that respectively operate on the computer system 500 and, for example, application programs executed by the first processor 502.

The first and second operating systems 521, 522 are operating systems for controlling the entire software operating on the computer system 500. Two operating systems are provided in the second embodiment.

As an example of the multiprocessor system of the second embodiment, it is complied such that the first and second tasks 523, 524 and the first operating system 521 operate on the first processor 502 and the third to n-th tasks 525, 526 and 527 and the second operating system 522 operate on the second processor 503.

The first operating system 521 manages executed states of the first and second tasks 523, 524 and a hardware state of the first processor 502. The second operating system 522 manages executed states of the third to n-th tasks 525, 526 and 527 and a hardware state of the second processor 503. Since one operating system is executed by each of a plurality of processors in the computer system 500, it is not necessary to provide a virtual machine environment. Thus, the hypervisor 120 described in the first embodiment is absent in the second embodiment. The number of the tasks, the number of the operating systems and the relationship of the tasks and the operating systems may not coincide with the example shown in FIG. 6.

The first and second level 1 cache storage devices 504, 505 are respectively storage means for temporarily storing data and commands referred to by the first and second processors 502, 503. In the case of installing the cache storage device in each individual processor, a snoop control is necessary to ensure the consistency of shared data, but it is not shown since it is not a main constituent element of the present invention. Generally, in the snoop control, writing operations of the individual processors are monitored and, when one processor performs a writing operation, a corresponding cache entry of the cache storage device used by another processor is invalidated or renewed. In this way, no logical contradiction occurs among cache storage devices corresponding to a plurality of processors.

The level 2 cache storage device 501 is shared by the first and second processors 502, 503, and is storage means for temporarily storing data and commands referred to via the first and second level 1 cache storage devices 504, 505 by the first and second processors 502, 503. The level 2 cache storage device 501 corresponds to the cache storage device 111 in FIG. 1. Although the cache storage device 111 is shared by a plurality of operating systems in the virtual machine system in the first embodiment, the level 2 cache storage device 501 is shared by a plurality of processors in the second embodiment.

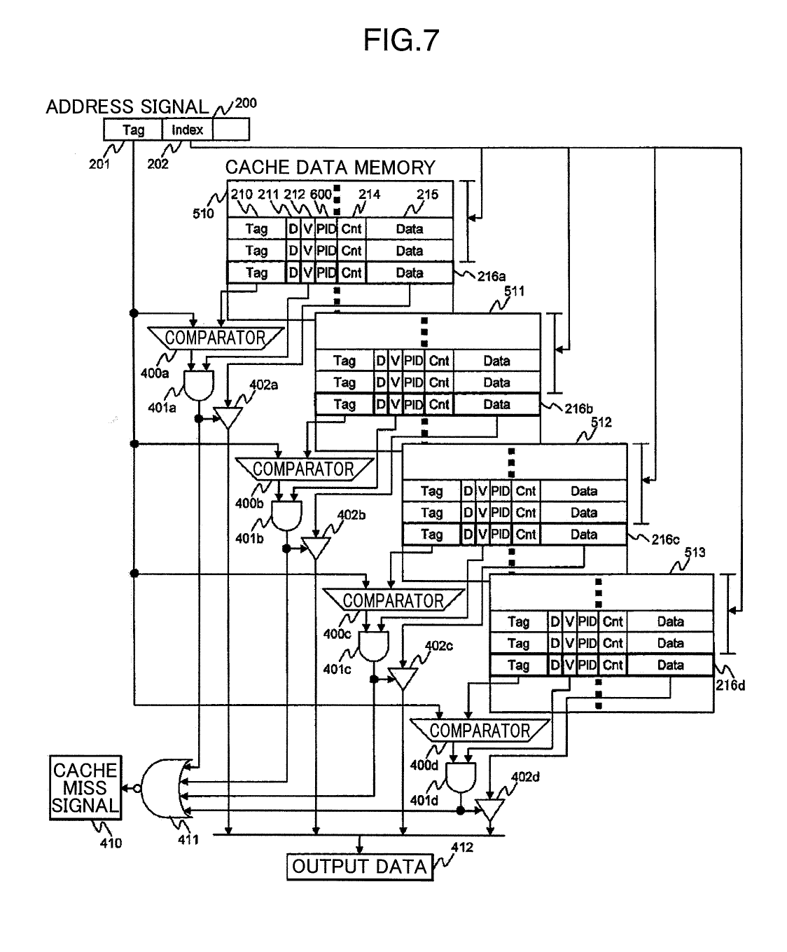

The level 2 cache storage device 501 is a set associative cache storage device and includes cache data memories divided in a plurality of ways. The set associative cache storage device is shown in FIG. 2 as described above. Although the cache data memories 510 to 513 divided in four ways are present in FIG. 6, it is also possible to install less than four ways or more than four ways. Since the level 2 cache storage device 501 is shared by the plurality of processors, a processor identifier indicating which processor is using the cache entry is mounted in each individual cache entry. The processor identifier is described with reference to FIG. 7.

The level 2 cache storage device 501 includes the cache data memories 510 to 513 described above, a replacement object selecting section 136, an access object selecting section 137, a buffer 138, a monitoring section 519, an input/output section 140 and a cache entry selecting section 141. A reference time computing section 514, a processor executed state storage 515 and the monitoring section 519 as constituent elements different from those of the first embodiment are described below.

The monitoring section 519 monitors power control commands executed by the first and second processors 502, 503 by checking the status register 115 and notifies state changes of the processors executing these power control commands to the reference time computing section 514. The power control command includes a sleep command, a power supply control command and a clock control command. Each of the first and second processor 502, 503 issues the power control command in the case of entering a sleep mode due to the number and states of tasks operating on the first or second operating system 521, 522, and the first and second processors 502, 503 execute the issued power control command. Further, the first and second processors 502, 503 perform a process of returning from the sleep mode to a normal operation mode when a processing load changes upon the occurrence of an interrupt or the like.

The cache entry setting section 141 sets the cache entry used by the processor having executed the power control command to a state used in the past using the executed states of a plurality of processors that are changed based on the power control command when a cache miss occurs and the cache entry to be replaced is selected from a plurality of cache entries. The cache entry setting section 141 sets the cache entry used by the processor in the sleep mode to the state used in the past by the processor in the normal operation mode.

The cache entry setting section 141 includes the reference time computing section 514 and a processor executed state storage 515.

The reference time computing section 514 receives notification from the monitoring section 519 and manages the operation mode of each individual processor using the processor executed state storage 515. The processor executed state storage 515 holds the processor identifiers and the executed states of the respective processors (normal operation mode or sleep mode) in the form of a table.

Although the processor executed state storage 515 holds the operation modes of the plurality of processors in the form of the table here, the operation modes of the plurality of processors may be stored in another format.

The reference time computing section 514 computes reference time data of a plurality of cache entries as candidates for a replacement object in response to an inquiry from the replacement object selecting section 136 and notifies the computed reference time data to the replacement object selecting section 136. The reference time computing section 514 outputs the reference time data of the cache entry used by the processor in the sleep mode as a least recently used value using the processor executed state storage 515 and the processor identifiers provided in the individual cache entries. The level 2 cache storage device 501 operates using a normal LRU algorithm when no processor in the sleep mode exists.

By the above construction, data in the cache entry used by the processor executed in the sleep mode can be selected as a replacement object, assuming this data as least recently used data in the cache entry. In this way, a control can be executed such that the data of the processor in the normal operation mode preferentially remains in the level 2 cache storage device 501. Further, the cache entry with a lower frequency of use by the transfer of the processor to the sleep mode can be effectively used by another processor, and the performance of the entire system can be improved.

The second embodiment does not relate to such a method enabling the cache entry to be used by another processor by uniformly invalidating data used by the processor having entered the sleep mode from the cache entry. Thus, the cache entry used in the past can be effectively used if necessary data remains to be stored in the level 2 cache storage device 501 when the processor having entered the sleep mode returns to the normal operation mode again.

In the second embodiment, the computer system 500 corresponds to an example of the shared cache controller, the memory 506 to an example of the main storage, the cache storage device 501 to an example of a cache storage device, the monitoring section 519 to an example of the monitoring section, the cache entry selecting section 141 to an example of the cache entry selecting section, the replacement object selecting section 136 to an example of the replacement object selecting section, the processor executed state storage 515 to an example of the executed state storage, and the reference time computing section 514 to an example of the reference time data generating section.

FIG. 7 is a diagram showing a detailed construction of the level 2 cache storage device relating to a cache entry selection process when the first or second processor 502 or 503 accesses the level 2 cache storage device 501 in response to a memory access command or the like.

An address signal 200 indicating data to be accessed includes an index number 202 indicating an offset in the cache data memory 510 to 513 and an upper address tag 201 other than the index number 202. In each of the individual cache data memories 510 to 513, the cache entry located at the offset designated by the index number 202 is an accessible cache entry. Cache hit detection is made among these four cache entries located at the offset designated by the index number 202.

Although only the four-way cache data memories 510 to 513 are shown for the sake of graphical representation in the second embodiment, the present invention is not particularly limited to this and the level 2 cache storage device 501 can be equipped with cache data memories of less than four ways or more than four ways and the number of the cache entries that can become replacement objects increases or decreases with the number of the ways.

Each cache entry in each individual cache data memory is made up of fields including at least an upper address tag 210, a dirty bit 211, a valid bit 212, a processor identifier 600, a reference time counter 214 and cache data 215. Constituent elements in FIG. 7 other than the processor identifier 600 are similar to those of FIG. 3 and operate as in FIG. 3 and, therefore, are not described in the second embodiment. In the case of access to the cache entry by the individual processor, the number of this processor is stored in the processor identifier 600.

As described above, the cache entry includes the processor identifier 600 for identifying the processor using this cache entry, the reference time counter (reference time count value) 214 which is counted according to time at which this cache entry is referred to and whose value increases as the reference time becomes older, and the cache data 215.

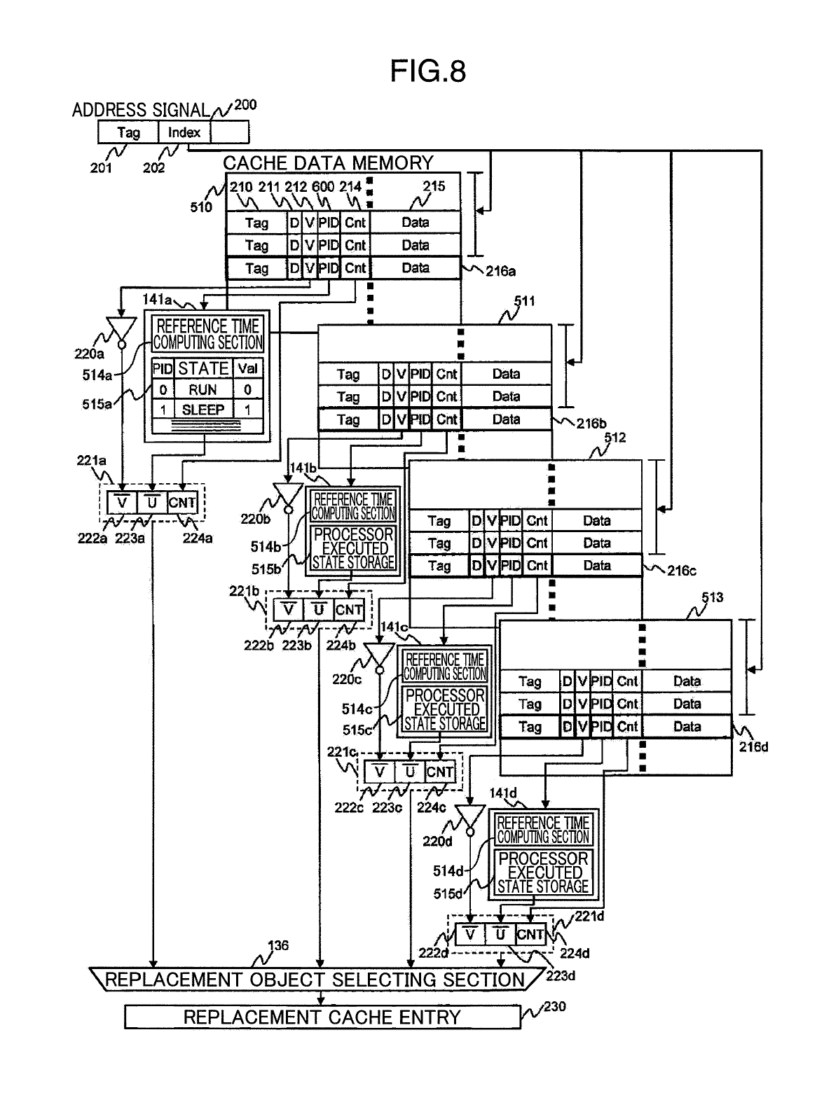

FIG. 8 is a diagram showing a detailed construction of the level 2 cache storage device 501 relating to the cache entry replacement process in the event of a cache miss as a result of the cache entry selection process shown in FIG. 7. In FIG. 8, constituent elements other than the processor identifier 600, reference time computing sections 514a to 514d and processor executed state storages 515a to 515d are the same as those in FIG. 4. The reference time computing sections 514a to 514d correspond to the reference time computing section 514 described with reference to FIG. 6.

The cache entry replacement process for replacing data in the cache entry by new data is described in detail below with reference to FIG. 8.

First of all, when it is necessary to read new data from the memory 506 and store it in the level 2 cache storage device 501 due to a cache miss or the like, the replacement object selecting section 136 receives a cache miss signal 410 from the access object selecting section 137 and starts the cache entry replacement process.

The replacement object selecting section 136 selects four cache entries in the cache data memories 510 to 513 using the index numbers 202 included in the address signals 200. Here, it is assumed that the cache entries 216a to 216d were selected.

One cache entry is selected as the replacement object out of these four cache entries 216a to 216d. Thus, in the level 2 cache storage device 501 of the second embodiment, the monitoring section 519 monitors the power control commands executed by the first and second processors 502, 503 and notifies state changes of the processors executing the power control command to the reference time computing section 514, and the reference time computing section 514 manages the executed states of the respective processors. Thus, the cache entry used by the processor having entered the sleep mode can be set to the least recently used state and another processor can effectively utilize the cache entry used by the processor having entered the sleep mode.

Each of the first and second processors 502, 503 issues the power control command in the case of entering the sleep mode due to the number and states of tasks operated on the corresponding one of the first and second operating systems 521, 522. Further, each of the first and second processors 502, 503 returns from the sleep mode to the normal operation mode when a processing load changes upon the occurrence of an interrupt or the like.

The reference time computing sections 514a to 514d manage the operation modes of the individual processors using the processor executed state storages 515a to 515d. Although the reference time computing sections 514a to 514d and the processor executed state storages 515a to 515d are mounted in the individual cache entry selecting sections 141a to 141d in the second embodiment, one reference time computing section 514 and one processor executed state storage 515 may be shared among the cache entry selecting sections 141a to 141d. In this way, data coherency can be more efficiently ensured.

In FIG. 8, contents of a table of only the processor executed state storage 515a are shown in detail. In the table stored in the processor executed state storage 515a of FIG. 8, two processors (identifiers “0” and “1”) exist and are respectively assumed to be in the normal operation mode and in the sleep mode. In FIG. 8, the processor identifiers are expressed by “0” and “1”, an executed state of the processor identifier in the normal operation mode is expressed by “RUN”, and that of the processor identifier in the sleep mode is expressed by “SLEEP”. The processor executed state storages 515a to 515d hold “0” in the case of the normal operation mode and “1” in the case of the sleep mode as an executed state value (Val) corresponding to the executed state of the processor.

Next, the reference time computing sections 514a to 514d generate reference time data corresponding to the respective cache entries 216a to 216d using the reference time counters 214 in the selected cache entries 216a to 216d, the valid bits 212 in the selected cache entries 216a to 216d and the executed state values (Val) corresponding to the executed states of the processors in the processor executed state storages 515a to 515d.

For example, reference time data 221a corresponding to the cache entry 216a is made up of an invalid bit 222a obtained by reversing the valid bit 212 using a negation operator 220a, a state bit 223a using the executed state value (Val) corresponding to the executed state of the processor stored in the processor executed state storage 515a and a reference counter bit 224a using the value of the reference time counter 214 as it is. Similarly, reference time data 221b to 221d corresponding to the cache entries 216b to 216d are made up of invalid bits 222b to 222d obtained by reversing the valid bits 212 of the respective cache entries using negation operators 220b to 220d, state bits 223b to 223d using the executed state values (Val) corresponding to the executed states of the processors stored in the processor executed state storage 515b to 515d and reference counter bits 224b to 224d using the values of the reference time counters 214 as they are.

The replacement object selecting section 136 receives and compares these reference time data 221a to 221d, selects the cache entry with a maximum numerical value of the reference time data as the replacement object, and outputs the selected cache entry as a replacement cache entry 230. Further, the replacement object selecting section 136 writes data in the same way as the cache entry to be replaced in the buffer 138 and writes data before the replacement on the memory 506 if there is any data thrown out by the replacement of the selected cache entry.

Specifically, if there is one cache entry whose valid bit 212 is OFF out of the selected cache entries 216a to 216d, the invalid bit 222a to 222d as the most valid bit in the reference time data 221a to 221d is ON. Therefore, the reference time data of this cache entry is largest.

Further, if all the cache entries 216a to 216d are effective, i.e. the valid bits 212 of all the cache entries 216a to 216d are ON, the invalid bits 222a to 222d as the most valid bits in the reference time data 221a to 221d are all “0”. At this time, if there is one cache entry used by the processor in the sleep mode out of the selected cache entries 216a to 216d, the state bit 223a to 223d as the second most valid bit in the reference time data 221a to 221d is ON. Therefore, the reference time data of this cache entry is largest.

Further, if all the cache entries 216a to 216d are effective and used by the processors in the normal operation mode, the invalid bits 222a to 222d as the most valid bits and the state bits 223a to 223d as the second most valid bits are all “0”. At this time, the reference counter bits 224a to 224d corresponding to the values of the reference time counters 214 of the cache entries 216a to 216d are used as they are. Thus, out of the reference time data 221a to 221d, the value of the reference time data corresponding to the least recently referred cache entry is largest.

In this way, the processor executed state storages 515a to 515d store the executed states of a plurality of processors that are changed in accordance with a power control command and executed state values that are set beforehand according to the executed states and are larger when corresponding to the sleep mode than when corresponding to the normal operation mode. Further, the reference time computing sections 514a to 514d generate the reference time data 221a to 221d including the executed state value and the reference time count value for each of a plurality of cache entries.

The replacement object selecting section 136 compares the reference time data 221a to 221d for the respective plurality of cache entries generated by the reference time computing sections 514a to 514d and selects the cache entry corresponding to the reference time data with the largest executed state value included in the reference time data as the cache entry to be replaced. The replacement object selecting section 136 compares the reference time data 221a to 221d for the respective plurality of cache entries generated by the reference time computing sections 514a to 514d and selects the cache entry corresponding to the reference time data with the largest reference time count value included in the reference time data as the cache entry to be replaced when all the executed state values included in the reference time data are the same.

By this construction, the cache entry whose valid bit 212 is not ON and the cache entry used by the processor in the sleep mode are prioritized as those to be replaced. Only when there is no such cache entry, the cache entry is replaced using the LRU algorithm. Thus, in the computer system in which a plurality of processors share the cache storage device, the cache entry no longer used by one processor can be preferentially used by another processor and the cache storage device of a limited size can be effectively utilized.

By the above, the cache entry that is not effective can be most prioritized as the replacement object and, then, the data of the cache entry used by the processor executed in the sleep mode can be selected as the replacement object, assuming this data as data of the least recently used cache entry. In this way, a control can be executed such that the data of the processors in the normal operation mode preferentially remain in the level 2 cache storage device 501.

The second embodiment does not relate to the method for uniformly invalidating data from the cache entry. Thus, the cache entry used in the past can be effectively used if the processor having entered the sleep mode returns to the normal operation mode again due to the states of devices or the like. Since the value of the state bit returns to “0” in the case of return to the normal operation mode, the replacement object is selected using the LRU algorithm.

### Third Embodiment

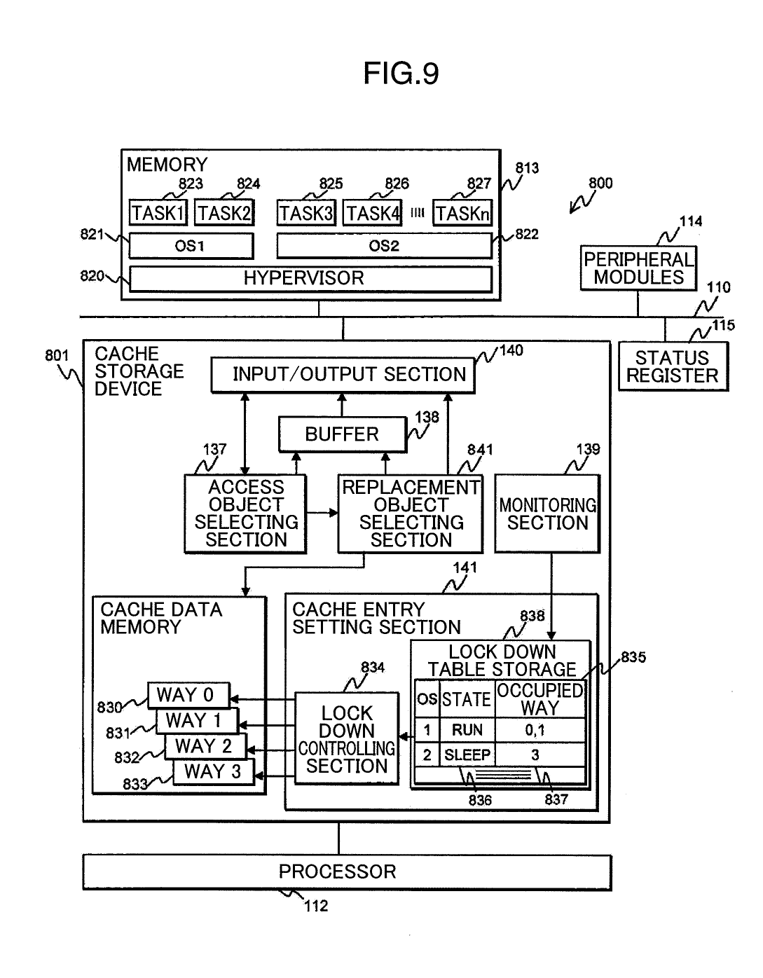

FIG. 9 is a diagram showing the construction of a computer system according to a third embodiment of the present invention. A computer system 800 is a virtual machine system for operating a plurality of operating systems on one processor. The computer system 800 is provided with an internal bus 110, a cache storage device 801, a processor 112, a memory 813, peripheral modules 114 and a status register 115. The cache storage device 801, the memory 813, the peripheral modules 114 and the status register 115 are respectively connected with the internal bus 110. The internal bus 110, the processor 112, the peripheral modules 114 and the status register 115 are the same constituent elements as those described with reference to FIG. 1.

The memory 813 includes first to n-th tasks 823 to 827, first and second operating systems 821, 822 and a hypervisor 820. The memory 113 of FIG. 1 includes three operating systems, whereas the memory 813 of FIG. 9 differs in including two operating systems, but the respective constituent elements are the same.

The cache storage device 801 is a set associative cache storage device similar to the cache storage device 111. In this case, the cache storage device 801 includes cache data memories 830 to 833 divided in a plurality of ways, a replacement object selecting section 841, an access object selecting section 137, a buffer 138, a monitoring section 139, an input/output section 140 and a cache entry selecting section 141. The cache data memories 830 to 833 are constructed similar to the above cache data memories 130 to 133, but it is not necessary to mount operating system identifiers in the individual cache entries. Further, since the access object selecting section 137, the buffer 138 and the monitoring section 139 and the input/output section 140 have the same constructions as in FIG. 1, they are not described.

The cache entry selecting section 141 includes a lock down controlling section 834 and a lock down table storage 838.

The lock down controlling section 834 specifies so that a designated way out of a plurality of cache data memories 830 to 833 is not selected as a replacement object. For example, if the cache data memory 831 is locked down by the lock down controlling section 834, any one of the cache data memories 830, 832 and 833 is selected as a replacement cache entry upon the occurrence of a cache miss.

The lock down table storage 838 stores a lock down table 835. The lock down table 835 is a table for designating executed states of the individual operating systems and ways occupied by the individual operating systems. Entries indicating operating system executed states 836 and occupied ways 837 exist in the lock down table 835.

The operating system executed states 836 indicate the executed states of the respective operating systems. In FIG. 9, it is indicated that the first operating system 821 is in a normal operation mode and the second operating system 822 is in a sleep mode. In FIG. 9, operating system identifiers are expressed by “1” and “2”, the executed state of the operating system in the normal operation mode is expressed by “RUN” and that of the operating system in the sleep mode is expressed by “SLEEP”.

The occupied ways 837 indicate cache data memories (ways) occupied and used by the respective operating systems. The way occupied by a certain operating system cannot be selected as the replacement object for another operating system. In an example of FIG. 9, the first operating system 821 occupies the cache data memory 830 of the way 0 and the cache data memory 831 of the way 1, and the second operating system 822 occupies the cache data memory 832 of way 3.

At this time, the lock down controlling section 834 monitors the operating systems being executed, and locks down the cache data memories 830, 831 of the ways 0, 1 occupied by the first operating system 821 when the second operating system 822 is operating. Thus, the cache data memories 830, 831 of the ways 0, 1 cannot be selected as the replacement object if the operating system other than the first operating system 821 is operating.

If the operating system is in the sleep mode, it affects the performance of the entire system that this operating system occupies the cache data memory. Accordingly, the lock down controlling section 834 refers to the operating system executed states 836 in the lock down table 835 and does not lock down the cache data memory of the way that should be occupied by the operating system in the sleep mode.

In the example of FIG. 9, it is assumed that the second operating system 822 occupies the cache data memory 832 of the way 3. At this time, the lock down controlling section 834 does not lock down the cache data memory 832 of the way 3 that should be occupied by the second operating system 822 in the case of judging that the first operating system 821 is operating and the second operating system 822 is in the sleep mode. In this way, the first operating system 821 can also select the cache data memory 832 of the way 3 as the replacement object and the faster execution of the program than normal can be executed.

As described above, the cache storage device 801 includes a plurality of ways (cache data memories 830 to 833) each including a plurality of cache entries. The lock down table storage 838 stores the executed states of a plurality of operating systems that are changed in accordance with a power control command and way identifiers for identifying the ways used by the operating system out of the plurality of ways. The lock down controlling section 834 refers to the lock down table storage 838, sets the way used by the operating system in the sleep mode as the way to be replaced and sets the way used by the operating system in the normal operation mode as the way that cannot be a replacement object.

The replacement object selecting section 841 selects the least recently used cache entry as the cache entry to be replaced out of the ways set as those to be replaced by the lock down controlling section 834.

In the third embodiment, the cache storage device 801 corresponds to an example of the cache storage device, the replacement object selecting section 841 to an example of the replacement object selecting section, the lock down controlling section 834 to an example of a lock down controlling section and the lock down table storage 838 to an example of the executed state storage.

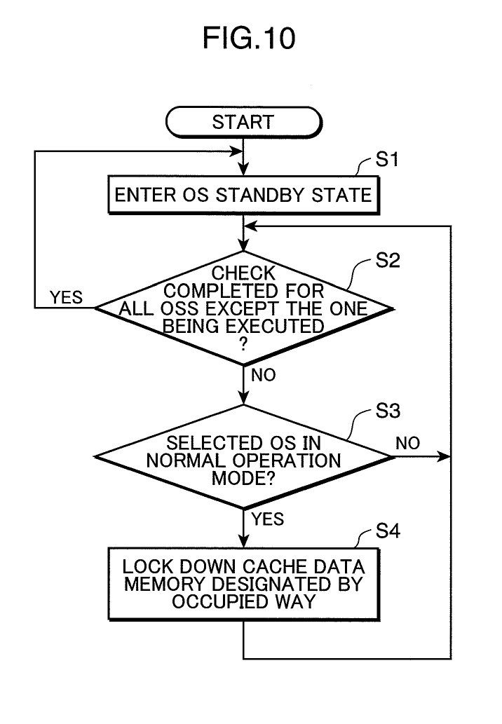

FIG. 10 is a flow chart showing the operation of the lock down controlling section 834 shown in FIG. 9. Although the lock down controlling section 834 shown in FIG. 9 is described to be a control circuit in the cache storage device 801, it may be, for example, a program in the hypervisor 820 as shown in FIG. 10. Regardless of whether the lock down controlling section 834 is a control circuit or a program, it can be realized by a similar process flow.

First of all, the lock down controlling section 834 enters a standby state waiting for the operating system switching (Step S1).

When the operating system is switched, the lock down controlling section 834 enters a processing of Step S2 and performs processings of Steps S3 and S4 for the operating systems other than the operating system to be executed next. In other words, the lock down controlling section 834 judges whether or not check as to whether or not all the operating systems other than the operating system to be executed next are in the normal operation mode has been completed (Step S2).

If it is judged that the check as to whether or not all the operating systems other than the operating system to be executed next are in the normal operation mode has not been completed (NO in Step S2), the lock down controlling section 834 selects the operating system which is other than the operating system to be executed next and for which the check as to the normal operation mode has not been completed. Then, the lock down controlling section 834 refers to the lock down table 835 and judges whether or not the selected operating system is in the normal operation mode (Step S3).

If the selected operating system is judged to be in the normal operation mode (YES in Step S3), the lock down controlling section 834 locks down the cache data memory designated by the occupied way 837 in the lock down table 835 (Step S4). On the other hand, if the selected operating system is judged not to be in the normal operation mode (NO in Step S3), the lock down controlling section 834 returns to the processing of Step S2.

On the other hand, if it is judged that the check as to whether or not all the operating systems other than the operating system to be executed next are in the normal operation mode has been completed (YES in Step S2), the lock down controlling section 834 returns to the processing of Step Si and enters the standby state for the operating system switching.

By using the construction shown in FIG. 9, the cache storage device can be effectively utilized according to the executed states of the operating systems by an easier method without storing the operating system identifiers in the cache storage device. Specifically, since the cache data memory used by the operating system in the normal operation mode is locked down, there is no likelihood that this cache data memory is thrown out by another operating system. Further, since the cache data memory of the operating system having entered the sleep mode is not locked down, another operating system can efficiently use the cache entry in the cache storage device.

In the third embodiment, the effect of speeding up the process can be expected as compared with a method for dividing a storage region of a cache storage device and completely allotting the divided storage regions to the individual operating systems. Further, since the third embodiment does not relates to the method for uniformly invalidating data from the cache entry, the cache entry used in the past can be effectively used if the operating system having entered the sleep mode returns to the normal operation mode again due to the states of devices or the like.

### Fourth Embodiment

In the first embodiment of the present invention, if any one of a plurality of operating systems enters the sleep mode, the cache entry used by this operating system is fully prioritized as the replacement object. However, there are cases where it is more effective to select the cache entry least recently used by the operating system in the normal operation mode as the replacement object.

For example, a low power consumption mode that operates with a lower speed clock than the normal operation mode is provided as an executed state of the operating system in addition to the sleep mode and the normal operation mode, the cache entry used by the operating system in the sleep mode is fully prioritized as the replacement object and the cache entry used by the operating system in the low power consumption mode is prioritized as the replacement object to some extent. In other words, cases where it is desirable to preferentially replace the cache entry least recently used by the operating system in the normal operation mode over the cache entry recently accessed by the operating system in the low power consumption mode can be dealt with.

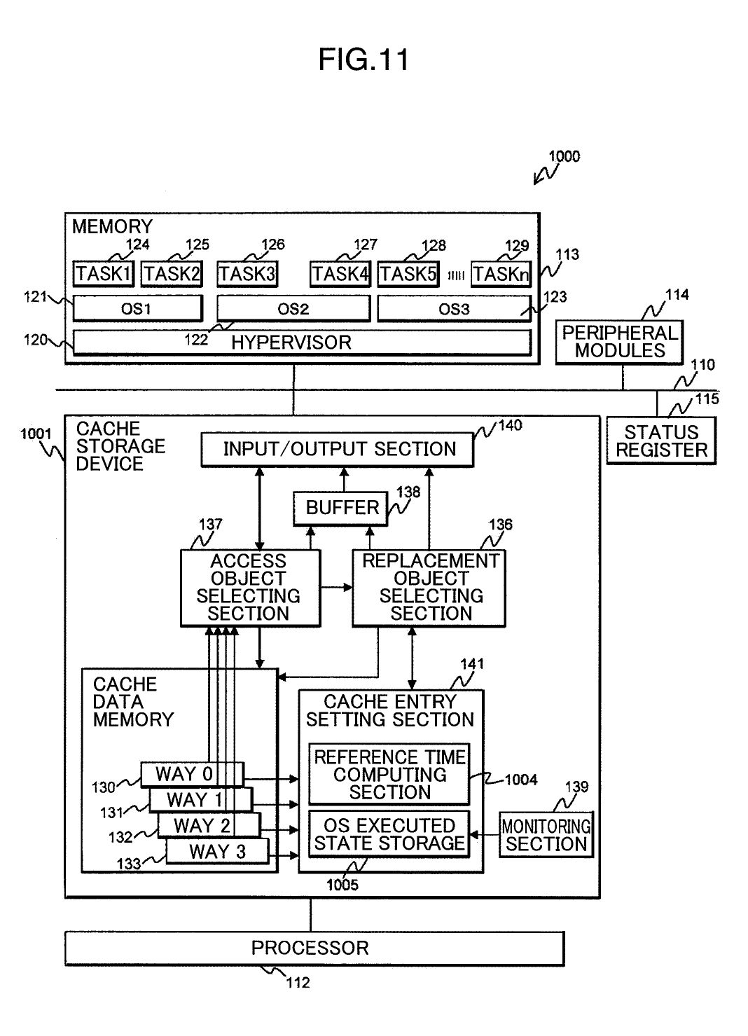

FIG. 11 is a diagram showing the construction of a computer system according to a fourth embodiment of the present invention, taking the low power consumption mode into consideration. A computer system 1000 is a virtual machine system for operating a plurality of operating systems on one processor.

The computer system 1000 is provided with an internal bus 110, a cache storage device 1001, a processor 112, a memory 113, peripheral modules 114 and a status register 115. The cache storage device 1001, the memory 113, the peripheral modules 114 and the status register 115 are respectively connected with the internal bus 110. Since the internal bus 110, the processor 112, the memory 113, the peripheral modules 114 and the status register 115 are the same constituent elements as those described with reference to FIG. 1, they are not described and only the cache storage device 1001 as a different constituent element is described.

With high integration of LSIs of recent years, it is also possible to mount a plurality of circuits constituting the computer system 1000 on one system LSI, but no limitation is made as to whether circuits are mounted on a single system LSI or mounted on different system LSIs in this fourth embodiment. Although the status register 115 is connected with the internal bus 110 in FIG. 11, it may be directly connected with the processor 112.

The cache storage device 1001 includes cache data memories 130 to 133, a replacement object selecting section 136, an access object selecting section 137, a buffer 138, a monitoring section 139, an input/output section 140 and a cache entry selecting section 141. The cache entry selecting section 141 includes a reference time computing section 1004 and an OS executed state storage 1005. The reference time computing section 1004 and the OS executed state storage 1005 which are constituent elements different from those of the first embodiment are described below.

The reference time computing section 1004 receives notification from the monitoring section 139 and manages the operation mode of the operating system executing a power control command using the OS executed state storage 1005. The OS executed state storage 1005 holds operating system identifiers for identifying the operating systems, executed states (normal operation mode, sleep mode and low power consumption mode) of the respective operating systems and unused time adding indices (unused time added values) corresponding to the executed states of the operating systems in the form of a table.

Although the OS executed state storage 1005 holds the operation modes of the operating systems and the unused time adding indices in the form of the table here, the operation modes of the operating systems and the unused time adding indices may be stored in another format.

The reference time computing section 1004 computes reference time data of a plurality of cache entries as candidates for a replacement object in response to an inquiry from the replacement object selecting section 136 and notifies the computed reference time data to the replacement object selecting section 136. The reference time computing section 1004 outputs the reference time data of the cache entry used by the operating system in the sleep mode as a least recently used value and the reference time data of the cache entry used by the operating system in the low power consumption mode as a value used in the past to some extent using the OS executed state storage 1005, the operating system identifiers provided for the individual cache entries and reference time counters. The cache storage device 1001 operates with a normal LRU algorithm if there is no operating system in the sleep mode or the low power consumption mode.

By the above construction, the data in the cache entry used by the operating system executed in the sleep mode is regarded as the least recently used data and the data in the cache entry used by the operating system operating in the low power consumption mode is regarded as data used in the past to some extent. Accordingly, a control can be executed such that the data of the operating system in the normal operation mode preferentially remains in the cache storage device 1001. In this way, the cache entry with a lower frequency of use by the transfer of the operating system to the sleep mode or the low power consumption mode can be effectively used by another operating system, and the performance of the entire system can be improved.

In the fourth embodiment, the computer system 1000 corresponds to an example of the shared cache controller, the memory 113 to an example of the main storage, the cache storage device 1001 to an example of the cache storage device, the monitoring section 139 to an example of the monitoring section, the cache entry selecting section 141 to an example of the cache entry selecting section, the replacement object selecting section 136 to an example of the replacement object selecting section, the OS executed state storage 1005 to an example of the executed state storage, and the reference time computing section 1004 to an example of the reference time data generating section.

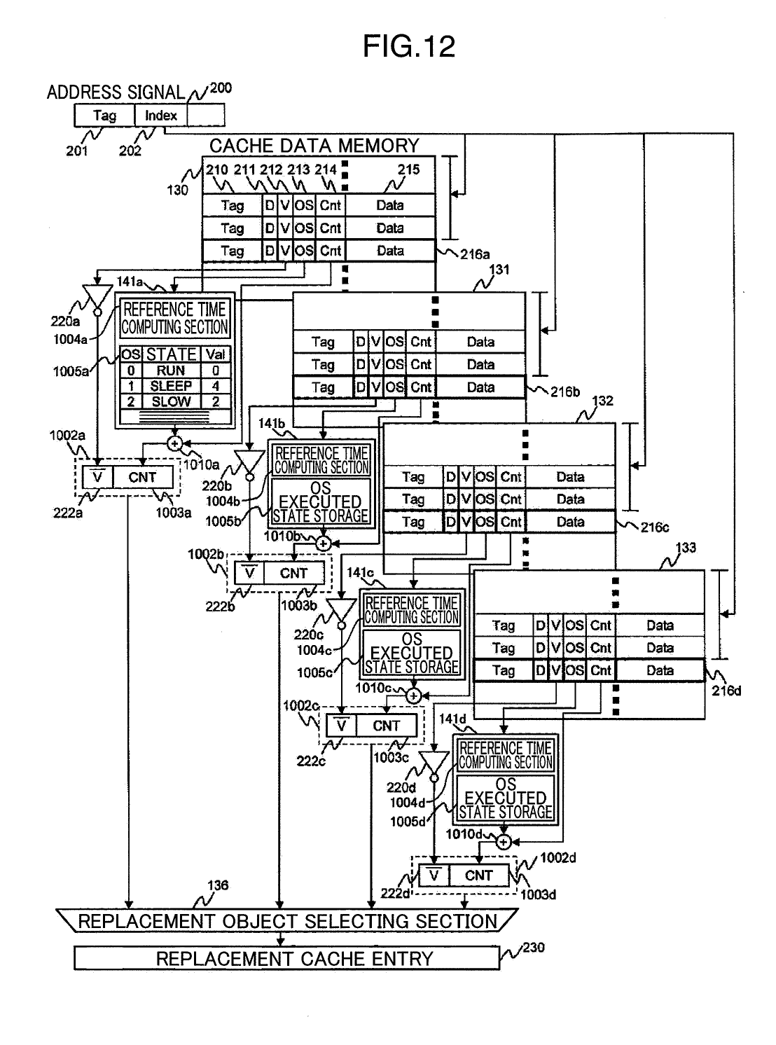

FIG. 12 is a diagram showing a detailed construction of the cache storage device 1001 relating to a cache entry replacement process in the case of a cache miss as a result of the cache entry selection process. In FIG. 12, constituent elements other than reference time computing sections 1004a to 1004d, OS executed state storages 1005a to 1005d, reference time data 1002a to 1002d, reference counter bits 1003a to 1003d and adders 1010a to 101d are the same constituent elements as those in FIG. 4. The reference time computing sections 1004a to 1004d correspond to the reference time computing section 1004 described with reference to FIG. 11 and the OS executed state storages 1005a to 1005d correspond to the OS executed state storage 1005 described with reference to FIG. 11.

The cache entry replacement process for replacing data in the cache entry by new data is described in detail below with reference to FIG. 12.

First of all, when it is necessary to read new data from the memory 113 and store it in the cache storage device 1001 due to a cache miss or the like, the replacement object selecting section 136 receives a cache miss signal 410 from the access object selecting section 137 and starts the cache entry replacement process.

The replacement object selecting section 136 selects four cache entries in the cache data memories 130 to 133 using index numbers 202 included in address signals 200. Here, it is assumed that the cache entries 216a to 216d were selected.

One cache entry is selected as the replacement object out of these four cache entries 216a to 216d. Thus, in the cache storage device 1001 of the fourth embodiment, the monitoring section 139 monitors a power control command executed by the processor 112 and notifies a state change of the operating system executing the power control command to the reference time computing section 1004, and the reference time computing section 1004 manages the executed states of the respective operating systems.

Thus, the cache entry used by the operating system having entered the sleep mode can be set to the least recently used state and the cache entry used by the operating system in the low power consumption mode can be set to the state used in the past to some extent. Accordingly, a control can be executed such that the data of the operating system in the normal operation mode preferentially remains in the cache storage device 1001. Simultaneously, even the cache entry least recently used by the operating system in the normal operation mode can be replaced preferentially over the one recently accessed by the operating system in the low power consumption mode.

Each of the first to third operating systems 121, 122 and 123 issues the power control command in the case of entering the sleep mode or the low power consumption mode due to the number and states of tasks operated on the individual operating system. Further, each of the first to third operating systems 121, 122 and 123 returns from the sleep mode or the low power consumption mode to the normal operation mode when a processing load changes upon the occurrence of an interrupt or the like.

The reference time computing sections 1004a to 1004d manage the operational states (executed states) of the individual operating systems using the OS executed state storages 1005a to 1005d. Although the reference time computing sections 1004a to 1004d and the OS executed state storages 1005a to 1005d are mounted in the individual cache entry selecting sections 141a to 141d in the fourth embodiment, one reference time computing section 1004 and one OS executed state storage 1005 may be shared among the cache entry selecting sections 141a to 141d. In this way, data coherency can be more efficiently ensured.

In FIG. 12, contents of a table of only the OS executed state storage 1005a are shown in detail. In the table stored in the OS executed state storage 1005a of FIG. 12, three operating systems exist. It is assumed that the operating system identifiers of the respective three operating systems are “0”, “1” and “2”, the respective executed states thereof are the normal operation mode, the sleep mode and the low power consumption mode, and unused time adding indices (Val) thereof are “0”, “4” and “2”.

In FIG. 12, an executed state of the operating system in the normal operation mode is expressed by “RUN”, that of the operating system in the sleep mode by “SLEEP” and that of the operating system in the low power consumption mode by “SLOW”.

In other words, the OS executed state storages 1005a to 1005d hold “0” in the case of the normal operation mode, “2” in the case of the low power consumption mode and “4” in the case of the sleep mode as an unused time adding index.

Next, the reference time computing sections 1004a to 1004d generate reference time data corresponding to the respective cache entries 216a to 216d using reference time counters 214 in the selected cache entries 216a to 216d, valid bits 212 in the selected cache entries 216a to 216d and the unused time adding indices (Val) in the OS executed state storages 1005a to 1005d.

Reference time data 1002a corresponding to the cache entry 216a is made up of an invalid bit 222a obtained by reversing the valid bit 212 using a negation operator 220a and a reference counter bit 1003a obtained by adding the unused time adding index (Val) stored in the OS executed state storage 1005a to the value of the reference time counter 214 of the cache entry using the adder 1010a. Similarly, reference time data 1002b to 1002d corresponding to the cache entries 216b to 216d are made up of invalid bits 222b to 222d obtained by reversing the valid bits 212 of the respective cache entries using negation operators 220b to 220d and reference counter bits 1003b to 1003d obtained by adding the unused time adding indices (Val) stored in the OS executed state storages 1005b to 1005d to the values of the reference time counters 214 of the respective cache entries.

The replacement object selecting section 136 receives and compares these reference time data 1002a to 1002d, selects the cache entry with a maximum numerical value of the reference time data as the replacement object, and outputs the selected cache entry as a replacement cache entry 230. Further, the replacement object selecting section 136 writes data in the same way as the cache entry to be replaced in the buffer 138 and writes data before the replacement on the memory 113 if there is any data thrown out by the replacement of the selected cache entry.

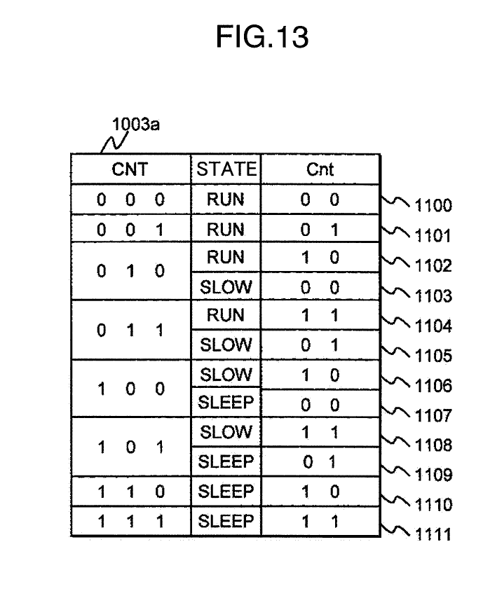

FIG. 13 is a table showing possible values of the reference counter bit 1003a of reference time data 1002a. FIG. 13 shows that the value of the reference counter bit (“CNT”) 1003a depends on in which one of the normal operation mode (“RUN”), the sleep mode (“SLEEP”) and the low power consumption mode (“SLOW”) the executed state of the operating system is and a change of the value of the reference time counter (“Cnt”) 214.

For example, in the case of a record 1103, the executed state of the operating system is the low power consumption mode and the value of the reference time counter 214 is “0”. Since the unused time adding index corresponding to the low power consumption mode is “2”, the value of the reference counter bit 1003a is “2” by adding the value of the reference time counter 214 and the unused time adding index. Further, in the case of a record 1104, the executed state of the operating system is the normal operation mode and the value of the reference time counter 214 is “3”. Since the unused time adding index corresponding to the normal operation mode is “0”, the value of the reference counter bit 1003a is “3” by adding the value of the reference time counter 214 and the unused time adding index. It should be noted that the respective values shown in FIG. 13 are expressed by binary numbers.

Here, if the records 1103 and 1104 are compared, the value of the reference counter bit in the record 1104 is larger than that of the reference counter bit in the record 1104. Thus, it can be understood that even the cache entry used by the operating system in the normal operation mode (record 1104) can be prioritized as the replacement object over the cache entry used by the operating system in the low power consumption mode (record 1103) in some cases.

As described above, the OS executed state storages 1005a to 1005d store the executed states of the operating systems and the unused time adding indices indicating the values to be added to the reference time count values according to the executed states. Further, the reference time computing sections 1004a to 1004d add the unused time adding indices corresponding to the executed states of the operating systems using the cache entries to the reference time count values included in the cache entries and generates the reference time data 1002a to 1002d including the reference time count value for each of a plurality of cache entries.

The replacement object selecting section 136 selects the cache entry corresponding to the maximum one of a plurality of reference time count values included in a plurality of reference time data 1002a to 1002d generated by the reference time computing sections 1004a to 1004d as the cache entry to be replaced.

The unused time adding index corresponding to the sleep mode is larger than that corresponding to the low power consumption mode. Further, the unused time adding index corresponding to the low power consumption mode is larger than that corresponding to the normal operation mode and smaller than that corresponding to the sleep mode.

By this construction, the cache entry whose valid bit 212 is not ON is selected as the most preferential replacement object and then the cache entries used by the operating systems in the sleep mode and the low power consumption mode are preferentially selected as the replacement object. Further, it is possible to preferentially select the cache entry used by the operating system in the low power consumption mode to some extent over that used by the operating system in the normal operation mode. In this way, in the system in which a plurality of operating systems share the cache storage device, the cache entry with a lower frequency of use by one operating system can be preferentially used by another operating system, and the cache storage device of a limited size can be effectively utilized.

By the above, it becomes possible to most preferentially select the invalid cache entry as the replacement object, provide the low power consumption mode that operates with a lower speed clock than the normal operation mode as the executed state of the operating system in addition to the sleep mode and the normal operation mode, fully prioritize the cache entry used by the operating system in the sleep mode as the replacement object and preferentially prioritize the cache entry used by the operating system in the low power consumption mode as the replacement object to some extent.

Such as when one operating system enters the low power consumption mode (means the mode operating at a low speed clock here) from the normal operation mode, the operating system in the low power consumption mode operates despite its low speed unlike the sleep mode. Thus, the cache entry used by the operating system in this low power consumption mode is not uniformly set to the least recently used state, but the priority of the cache entry to be replaced is varied according to the executed state of the operating system. In this way, the operating system in the low power consumption mode is prioritized as the replacement object only to some extent, wherefore the cache entries can be effectively used.

The fourth embodiment does not relate to the method for uniformly invalidating data from the cache entry. Thus, the cache entry used in the past can be effectively used if the operating system having entered the sleep mode or the low power consumption mode returns to the normal operation mode again due to the states of devices or the like. In the case of return to the normal operation mode, the cache storage device selects the replacement object using the LRU algorithm.

### Fifth Embodiment

In the second embodiment of the present invention, if any one of the plurality of processors enters the sleep mode, the cache entry used by this processor is fully prioritized as the replacement object. However, there are cases where it is more effective to select the cache entry least recently used by the processor in the normal operation mode as the replacement object.

For example, a low power consumption mode that operates with a lower speed clock than the normal operation mode is provided as an executed state of the processor in addition to the sleep mode and the normal operation mode, the cache entry used by the processor in the sleep mode is fully prioritized as the replacement object and the cache entry used by the processor in the low power consumption mode is prioritized as the replacement object to some extent. In other words, cases where it is desirable to preferentially replace the cache entry least recently used by the processor in the normal operation mode over the cache entry recently accessed by the processor in the low power consumption mode can be dealt with.

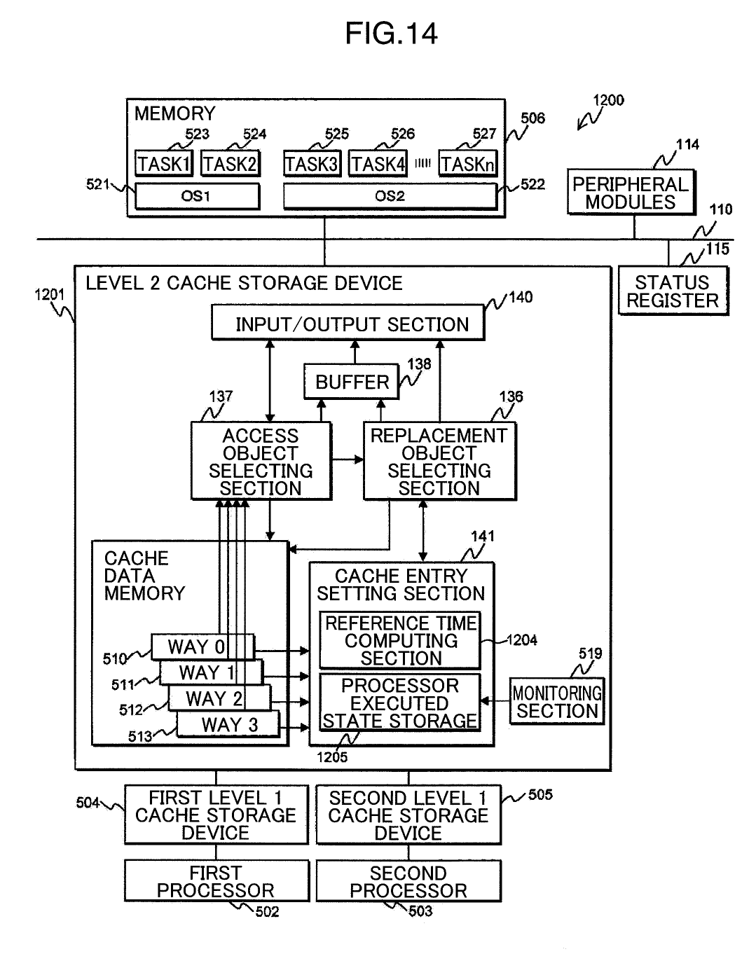

FIG. 14 is a diagram showing the construction of a computer system according to a fifth embodiment of the present invention, taking the low power consumption mode into consideration. A computer system 1200 is a multiprocessor system in which a plurality of processors share a memory and a cache storage device.

The computer system 1200 is provided with an internal bus 110, a plurality of processors (first processor 502 and second processor 503), a plurality of level 1 cache storage devices (first level 1 cache storage device 504 and second level 1 cache storage device 505), a level 2 cache storage device 1201, a memory 506, peripheral modules 114 and a status register 115. Since the internal bus 110, the plurality of processors (first processor 502 and second processor 503), the plurality level 1 cache storage devices (first level 1 cache storage device 504 and second level 1 cache storage device 505), the memory 506, the peripheral modules 114 and the status register 115 are the same constituent elements as those described with reference to FIG. 6, they are not described and only the level 2 cache storage device 1201 as a different constituent element is described.

With high integration of LSIs of recent years, it is also possible to mount a plurality of circuits constituting the computer system 1200 on one system LSI, but no limitation is made as to whether circuits are mounted on a single system LSI or mounted on different system LSIs in this fifth embodiment. Although the status register 115 is connected with the internal bus 110 in FIG. 14, it may be directly connected with the first and second processors 502, 503.

The level 2 cache storage device 1201 is shared by the first and second processors 502, 503, and is storage means for temporarily storing data and commands referred to via the first and second level 1 cache storage devices 504, 505 by the first and second processors 502, 503. The level 2 cache storage device 1201 includes cache data memories 510 to 513, a reference time computing section 1204, a processor executed state storage 1205, a replacement object selecting section 136, an access object selecting section 137, a buffer 138, a monitoring section 519 and an input/output section 140. The reference time computing section 1204 and the processor executed state storage 1205 as constituent elements different from those of the second embodiment are described below.

The reference time computing section 1204 receives notification from the monitoring section 519 and manages the operation modes of the individual processors using the processor executed state storage 1205. The processor executed state storage 1205 holds processor identifiers for identifying the processors, executed states of the respective processors (normal operation mode, sleep mode and low power consumption mode) and unused time adding indices corresponding to the executed states of the processors in the form of a table.

Although the processor executed state storage 1205 holds the operation modes of the processors and the unused time adding indices in the form of the table here, the operation modes of the processors and the unused time adding indices may be stored in another format.

The reference time computing section 1204 computes reference time data of a plurality of cache entries as candidates for a replacement object in response to an inquiry from the replacement object selecting section 136 and notifies the computed reference time data to the replacement object selecting section 136. The reference time computing section 1204 outputs the reference time data of the cache entry used by the processor in the sleep mode as a least recently used value and the reference time data of the cache entry used by the processor in the low power consumption mode as a value used in the past to some extent, using the processor executed state storage 1205, the processor identifiers provided in the individual cache entries and reference time counters. The level 2 cache storage device 1201 operates using a normal LRU algorithm when no processor in the sleep mode or in the low power consumption mode exists.

By the above construction, data in the cache entry used by the processor executed in the sleep mode is regarded as least recently used data and data in the cache entry used by the processor operated in the low power consumption mode is regarded as data used in the past to some extent. Accordingly, a control can be executed such that the data of the processor in the normal operation mode preferentially remains in the level 2 cache storage device 1201. In this way, the cache entry with a lower frequency of use by the transfer of the processor to the sleep mode or the low power consumption mode can be effectively used by another processor, and the performance of the entire system can be improved.

In the fifth embodiment, the computer system 1200 corresponds to an example of the shared cache controller, the memory 506 to an example of the main storage, the level 2 cache storage device 1201 to an example of the cache storage device, the monitoring section 519 to an example of the monitoring section, the cache entry selecting section 141 to an example of the cache entry selecting section, the replacement object selecting section 136 to an example of the replacement object selecting section, the processor executed state storage 1205 to an example of the executed state storage, and the reference time computing section 1204 to an example of the reference time data generating section.

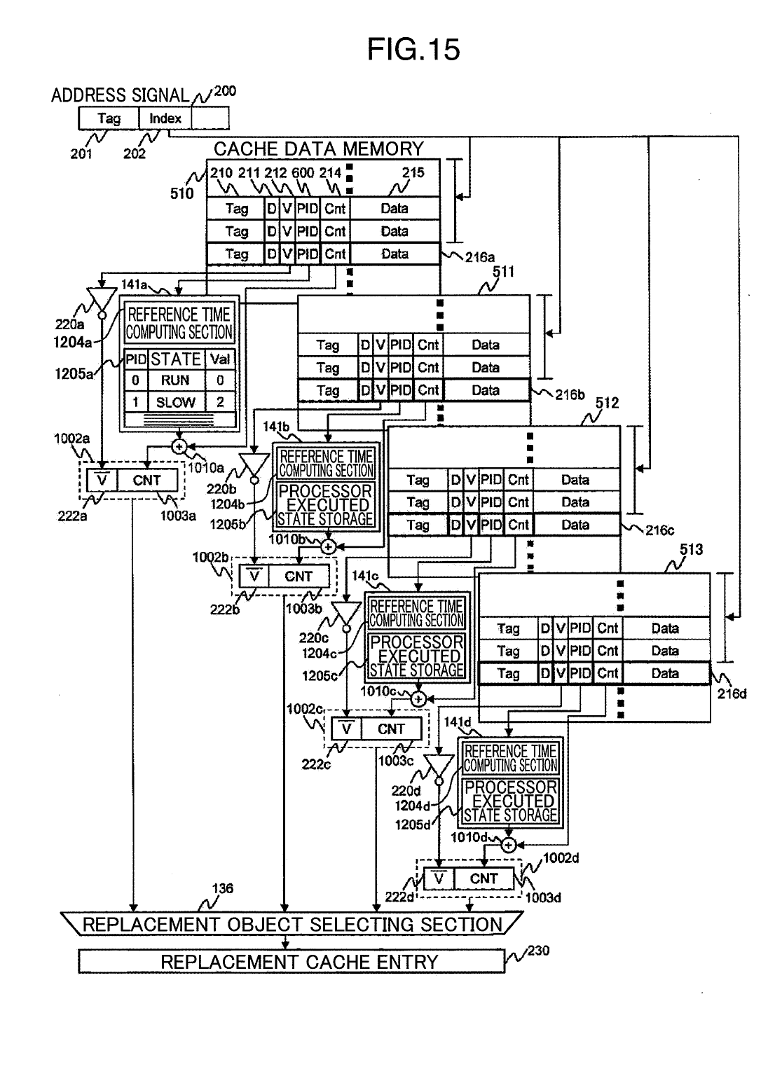

FIG. 15 is a diagram showing a detailed construction of the level 2 cache storage device 1201 relating to a cache entry replacement process in the case of a cache miss as a result of a cache entry selection process. In FIG. 15, constituent elements other than reference time computing sections 1204a to 1204d and processor executed state storages 1205a to 1205d are the same constituent elements as those in FIG. 8 or 12. The reference time computing sections 1204a to 1204d correspond to the reference time computing section 1204 described with reference to FIG. 14 and the processor executed state storages 1205a to 1205d correspond to the processor executed state storage 1205 described with reference to FIG. 14.

The cache entry replacement process for replacing data in the cache entry by new data is described in detail below with reference to FIG. 15.

First of all, when it is necessary to read new data from the memory 506 and store it in the level 2 cache storage device 1201 due to a cache miss or the like, the replacement object selecting section 136 receives a cache miss signal 410 from the access object selecting section 137 and starts the cache entry replacement process.

The replacement object selecting section 136 selects four cache entries in the cache data memories 510 to 513 using index numbers 202 included in address signals 200. Here, it is assumed that the cache entries 216a to 216d were selected.

One cache entry is selected as the replacement object out of these four cache entries 216a to 216d. Thus, in the level 2 cache storage device 1201 of the fifth embodiment, the monitoring section 519 monitors a power control command executed by the first and second processors 502, 503 and notifies state changes of the processors executing the power control commands to the reference time computing section 1204, and the reference time computing section 1204 manages the executed states of the respective processors.

Thus, the cache entry used by the processor entering the sleep mode can be set to the least recently used state and the cache entry used by the processor operating in the low power consumption mode can be set to the state used in the past to some extent. Accordingly, a control can be executed such that the data of the processor in the normal operation mode preferentially remains in the level 2 cache storage device 1201. Simultaneously, even the cache entry least recently used by the processor in the normal operation mode can be replaced preferentially over the one recently accessed by the processor in the low power consumption mode.

Each of the first and second processors 502, 503 issues the power control command in the case of entering the sleep mode or the low power consumption mode due to the number and states of tasks operated on corresponding first and second operating systems 521, 522. Further, each of the first and second processors 502, 503 returns from the sleep mode or the low power consumption mode to the normal operation mode when a processing load changes upon the occurrence of an interrupt or the like.

The reference time computing sections 1204a to 1204d manage the executed states and unused time adding indices of the individual processors using the processor executed state storages 1205a to 1205d. Although the reference time computing sections 1204a to 1204d and the processor executed state storages 1205a to 1205d are mounted in the individual cache entry selecting sections 141a to 141d in the fifth embodiment, one reference time computing section 1204 and one processor executed state storage 1205 may be shared among the cache entry selecting sections 141a to 141d. In this way, data coherency can be more efficiently ensured.

In FIG. 15, contents of a table of only the processor executed state storage 1205a are shown in detail. In the table stored in the processor executed state storage 1205a of FIG. 15, two processors exist. It is assumed that the processor identifiers of the respective two processors are “0” and “1”, the respective executed states thereof are the normal operation mode and the low power consumption mode, and the unused time adding indices (Val) thereof are “0” and “2”. The unused time adding index corresponding to the sleep mode is assumed to be “4”.

In FIG. 15, the executed state of the processor in the normal operation mode is expressed by “RUN” and that of the processor in the low power consumption mode is expressed by “SLOW”.

In other words, the processor executed state storages 1205a to 1205d hold “0” in the case of the normal operation mode, “2” in the case of the low power consumption mode and “4” in the case of the sleep mode as an unused time adding index.

Next, the reference time computing sections 1204a to 1204d generate reference time data corresponding to the respective cache entries 216a to 216d using reference time counters 214 in the selected cache entries 216a to 216d, valid bits 212 in the selected cache entries 216a to 216d and the unused time adding indices (Val) in the processor executed state storages 1205a to 1205d.

Reference time data 1002a corresponding to the cache entry 216a is made up of an invalid bit 222a obtained by reversing the valid bit 212 using a negation operator 220a and a reference counter bit 1003a obtained by adding the unused time adding index (Val) stored in the processor executed state storage 1205a to the value of the reference time counter 214 of the cache entry using the adder 1010a. Similarly, reference time data 1002b to 1002d corresponding to the cache entries 216b to 216d are made up of invalid bits 222b to 222d obtained by reversing the valid bits 212 of the respective cache entries using negation operators 220b to 220d and reference counter bits 1003b to 1003d obtained by adding the unused time adding indices (Val) stored in the processor executed state storages 1205b to 1205d to the values of the reference time counters 214 of the respective cache entries.

The replacement object selecting section 136 receives and compares these reference time data 1002a to 1002d, selects the cache entry with a maximum numerical value of the reference time data as the replacement object, and outputs the selected cache entry as a replacement cache entry 230. Further, the replacement object selecting section 136 writes data in the same way as the cache entry to be replaced in the buffer 138 and writes data before the replacement on the memory 506 if there is any data thrown out by the replacement of the selected cache entry.

In this way, the processor executed state storages 1205a to 1205d store the executed states of the processors and the unused time adding indices indicating the values to be added to the reference time count values according to the executed states. The reference time computing sections 1204a to 1204d generate the reference time data 1002a to 1002d including the reference time count value for each of a plurality of cache entries by adding the unused time adding index corresponding to the executed state of the processor using the cache entry to the reference time count value included in the cache entry.

The replacement object selecting section 136 selects the cache entry corresponding to the maximum one of a plurality of reference time count values included in a plurality of reference time data 1002a to 1002d generated by the reference time computing sections 1204a to 1204d as the cache entry to be replaced.

The unused time adding index corresponding to the sleep mode is larger than that corresponding to the low power consumption mode. Further, the unused time adding index corresponding to the low power consumption mode is larger than that corresponding to the normal operation mode and smaller than that corresponding to the sleep mode.

By this construction, the cache entry whose valid bit 212 is not ON is selected as the most preferential replacement object and then the cache entries used by the processors in the sleep mode and the low power consumption mode are preferentially selected as the replacement object. Further, it is possible to preferentially select the cache entry used by the processor in the low power consumption mode to some extent over that used by the processor in the normal operation mode. In this way, in the system in which a plurality of processors share the cache storage device, the cache entry with a lower frequency of use by one processor can be preferentially used by another processor, and the cache storage device of a limited size can be effectively utilized.

By the above, it becomes possible to most preferentially select the invalid cache entry as the replacement object, provide the low power consumption mode that operates with a lower speed clock than the normal operation mode as the executed state of the processor in addition to the sleep mode and the normal operation mode, fully prioritize the cache entry used by the processor in the sleep mode as the replacement object and preferentially prioritize the cache entry used by the processor in the low power consumption mode as the replacement object to some extent.

Such as when one processor enters the low power consumption mode (means the mode operating at a low speed clock here) from the normal operation mode, the processor in the low power consumption mode operates despite its low speed unlike the sleep mode. Thus, the cache entry used by the processor in this low power consumption mode is not uniformly set to the least recently used state, but the priority of the cache entry to be replaced is varied according to the executed state of the processor. In this way, the processor in the low power consumption mode is prioritized as the replacement object to some extent, whereby the cache entry can be effectively used.

The fifth embodiment does not relate to the method for uniformly invalidating data from the cache entry. Thus, the cache entry used in the past can be effectively used if the processor having entered the sleep mode or the low power consumption mode returns to the normal operation mode again due to the states of devices or the like. In the case of return to the normal operation mode, the level 2 cache storage device selects the replacement object using the LRU algorithm.

### Sixth Embodiment

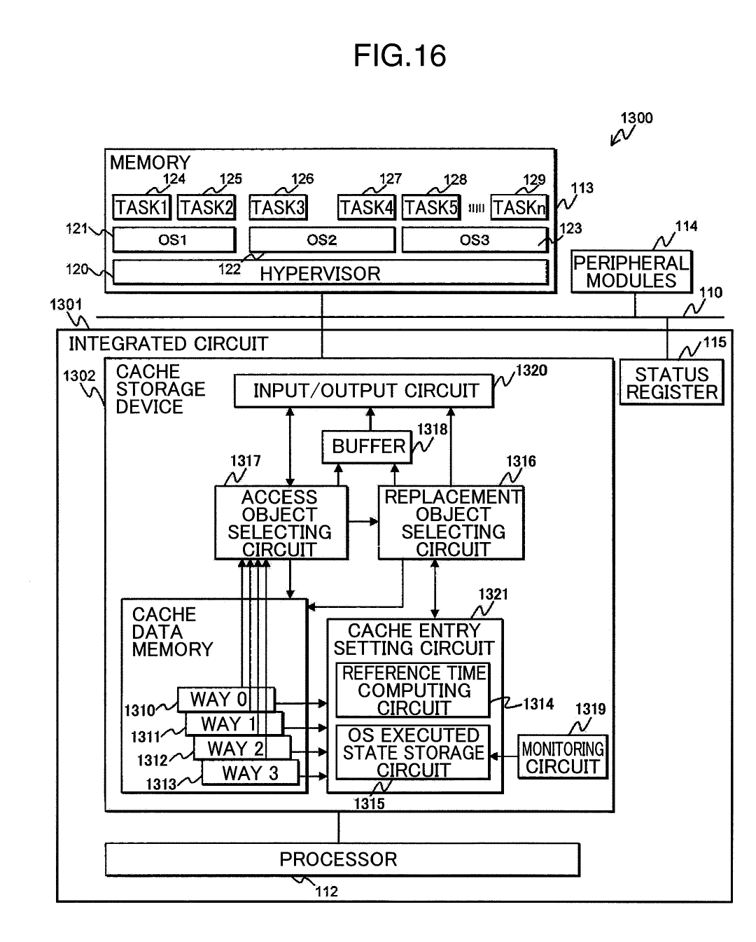

FIG. 16 is a diagram showing the construction of a computing system 1300 according to a sixth embodiment of the present invention. The computing system 1300 shown in FIG. 16 is provided with a memory 113, peripheral modules 114 and an integrated circuit 1301.

The integrated circuit 1301 includes a cache storage device 1302, a processor 112 and a status register 115. The cache storage device 1302 includes cache data memories 1310 to 1313, a cache entry setting circuit 1321, a replacement object selecting circuit 1316, an access object selecting circuit 1317, a buffer 1318, a monitoring circuit 1319 and an input/output circuit 1320. The cache entry setting circuit 1321 includes a reference time computing circuit 1314 and an OS executed state storage circuit 1315.

The cache storage device 1302, the cache data memories 1310 to 1313, the cache entry setting circuit 1321, the replacement object selecting circuit 1316, the access object selecting circuit 1317, the buffer 1318, the monitoring circuit 1319, the input/output circuit 1320, the reference time computing circuit 1314 and the OS executed state storage circuit 1315 respectively have the same functions as the cache storage device 111, the cache data memories 130 to 133, the cache entry setting section 141, the replacement object selecting section 136, the access object selecting section 137, the buffer 138, the monitoring section 139, the input/output section 140, the reference time computing section 134 and the OS executed state storage 135 in the first embodiment.

In this way, the cache storage device 1302, the status register 115 and the processor 112 can be mounted on one integrated circuit.

The above specific embodiments mainly embrace inventions having the following constructions.

A shared cache controller according to one aspect of the present invention comprises a main storage; a cache storage device shared by a plurality of operating systems or a plurality of processors and including a plurality of cache entries for storing data read from the main storage; a monitoring section for monitoring a power control command for controlling power supplied to a processor operating the plurality of operating systems or the plurality of processors; a cache entry setting section for setting the cache entry used by the operating system or the processor having executed the power control command to a state used in the past using executed states of the plurality of operating systems or the plurality of processors that are changed based on the power control command when a cache miss occurs and the cache entry to be replaced is selected from the plurality of cache entries; and a replacement object selecting section for selecting the cache entry set to the state used in the past by the cache entry setting section as the cache entry to be replaced.

A shared cache control method according to another aspect of the present invention comprises a cache storage step of storing data in a cache storage device which is shared by a plurality of operating systems or a plurality of processors and includes a plurality of cache entries for storing data read from a main storage; a monitoring step of monitoring a power control command for controlling power supplied to a processor operating the plurality of operating systems or the plurality of processors; a cache entry setting step of setting the cache entry used by the operating system or the processor having executed the power control command to a state used in the past using executed states of the plurality of operating systems or the plurality of processors that are changed based on the power control command when the cache entry to be replaced is selected from the plurality of cache entries; and a replacement object selecting step of selecting the cache entry set to the state used in the past in the cache entry setting step as the cache entry to be replaced.

An integrated circuit according to still another aspect of the present invention comprises a cache storage device shared by a plurality of operating systems or a plurality of processors and including a plurality of cache entries for storing data read from a main storage; a monitoring circuit for monitoring a power control command for controlling power supplied to a processor operating the plurality of operating systems or the plurality of processors; a cache entry setting circuit for setting the cache entry used by the operating system or the processor having executed the power control command to a state used in the past using executed states of the plurality of operating systems or the plurality of processors that are changed based on the power control command when the cache entry to be replaced is selected from the plurality of cache entries; and a replacement object selecting circuit for selecting the cache entry set to the state used in the past by the cache entry setting circuit as the cache entry to be replaced.

According to these constructions, the cache storage device is shared by the plurality of operating systems or the plurality of processors and includes the plurality of cache entries for storing the data read from the main storage. The power control command for controlling the power supplied to the processor operating the plurality of operating systems or the plurality of processors is monitored. Upon selecting the cache entry to be replaced out of the plurality of cache entries, the cache entry used by the operating system or processor having executed the power control command is set to the state used in the past using the executed states of the plurality of operating systems or the plurality of processors that are changed based on the power control command. Thereafter, the cache entry set to the state used in the past is selected as the cache entry to be replaced.

Thus, it becomes possible to preferentially use the cache entry in the cache storage device, which is no longer used by one operating system or one processor due to a change of the executed state, by another operating system or another processor in the case where the cache storage device is shared by the plurality of operating systems or the plurality of processors. Therefore, the plurality of operating systems or the plurality of processors can effectively utilize the cache storage device.

In the above shared cache controller, it is preferable that the power control command includes at least a sleep command for instructing the operation stop of the operating system; that the executed state includes at least a normal operation mode in which the operating system is operated with a high speed clock and a sleep mode in which the operation of the operating system is stopped; that the cache entry setting section sets the cache entry used by the operating system in the sleep mode to a state used in the past by the cache entry used by the operating system in the normal operation mode; and that the replacement object selecting section selects the cache entry set to the least recently used state by the cache entry setting section as the cache entry to be replaced.

According to this construction, the power control command includes at least the sleep command for instructing the operation stop of the operating system, and the executed state includes at least the normal operation mode in which the operating system is operated with a high speed clock and the sleep mode in which the operation of the operating system is stopped. The cache entry used by the operating system in the sleep mode is set to the state used in the past by the cache entry used by the operating system in the normal operation mode. The cache entry set to the least recently used state is selected as the cache entry to be replaced.

Thus, the operating system in the normal operation mode can use the cache entry used by the operating system in the sleep mode and the plurality of operating systems can effectively utilize one cache storage device.

In the above shared cache controller, it is preferable that each cache entry includes an operating system identifier for identifying the operating system using the cache entry, a reference time count value which is counted according to reference time, at which the cache entry is referred, and increases as the reference time becomes older, and data; that the cache entry setting section includes an executed state storage for storing the executed states of the plurality of operating systems that are changed based on the power control command and executed state values which are set beforehand according to the executed states and are larger when corresponding to the sleep mode than when corresponding to the normal operation mode, and a reference time data generating section for generating reference time data including the executed state value and the reference time count value for each of the plurality of cache entries; and that the replacement object selecting section compares the reference time data of the respective plurality of cache entries generated by the reference time data generating section and selects the cache entry corresponding to the reference time data with the maximum executed state value as the cache entry to be replaced.

According to this construction, each cache entry includes the operating system identifier for identifying the operating system using the cache entry, the reference time count value that is counted according to the reference time, at which the cache entry is referred, and increases as the reference time becomes older, and the data. The executed state storage stores the executed states of the plurality of operating systems that are changed based on the power control command and the executed state values that are set beforehand according to the executed states and are larger when corresponding to the sleep mode than when corresponding to the normal operation mode. The reference time data including the executed state value and the reference time count value is generated for each of the plurality of cache entries, the generated reference time data of the respective plurality of cache entries are compared, and the cache entry corresponding to the reference time data with the maximum executed state value is selected as the cache entry to be replaced.

Thus, the cache entry used by the operating system in the sleep mode is specified by comparing the executed state values corresponding to the respective cache entries, wherefore the cache entry to be replaced can be easily selected.

In the above shared cache controller, the replacement object selecting section preferably compares the reference time data of the respective plurality of cache entries generated by the reference time data generating section and selects the cache entry corresponding to the reference time data with the maximum reference time count value as the cache entry to be replaced when the executed state values included in the reference time data are all the same.

According to this construction, the reference time data of the respective plurality of cache entries are compared and the cache entry corresponding to the reference time data with the maximum reference time count value is selected as the cache entry to be replaced when the executed state values included in the reference time data are all the same.

Thus, even if the executed states of the respective operating systems using the plurality of cache entries are same, the cache entry to be replaced is selected based on the reference times of the cache entries. Therefore, the cache entry to be replaced can be more reliably selected.

In the above shared cache controller, it is preferable that the power control command includes at least a sleep command for instructing the operation stop of the processor; that the executed state includes a normal operation mode in which the processor is operated with a high speed clock and a sleep mode in which the operation of the processor is stopped; that the cache entry setting section sets the cache entry used by the processor in the sleep mode to a state used in the past by the cache entry used by the processor in the normal operation mode; and that the replacement object selecting section selects the cache entry set to the least recently used state by the cache entry setting section as the cache entry to be replaced.

According to this construction, the power control command includes at least the sleep command for instructing the operation stop of the processor, and the executed state includes the normal operation mode in which the processor is operated with a high speed clock and the sleep mode in which the operation of the processor is stopped. The cache entry used by the processor in the sleep mode is set to the state used in the past by the cache entry used by the processor in the normal operation mode. Then, the cache entry set to the least recently used state is selected as the cache entry to be replaced.

Thus, the processor in the normal operation mode can use the cache entry used by the processor in the sleep mode and the plurality of processors can effectively utilize one cache storage device.

In the above shared cache controller, it is preferable that each cache entry includes a processor identifier for identifying the processor using the cache entry and a reference time count value which is counted according to reference time, at which the cache entry is referred, and increases as the reference time becomes older, and data; that the cache entry setting section includes an executed state storage for storing the executed states of the plurality of processors that are changed based on the power control command and executed state values which are set beforehand according to the executed states and are larger when corresponding to the sleep mode than when corresponding to the normal operation mode, and a reference time data generating section for generating reference time data including the executed state value and the reference time count value for each of the plurality of cache entries; and that the replacement object selecting section compares the reference time data of the respective plurality of cache entries generated by the reference time data generating section and selects the cache entry corresponding to the reference time data with the maximum executed state value as the cache entry to be replaced.

According to this construction, each cache entry includes the processor identifier for identifying the processor using the cache entry, the reference time count value that is counted according to the reference time, at which the cache entry is referred, and increases as the reference time becomes older, and the data. The executed state storage stores the executed states of the plurality of processors that are changed based on the power control command and the executed state values that are set beforehand according to the executed states and are larger when corresponding to the sleep mode than when corresponding to the normal operation mode. The reference time data including the executed state value and the reference time count value is generated for each of the plurality of cache entries, the generated reference time data of the respective plurality of cache entries are compared, and the cache entry corresponding to the reference time data with the maximum executed state value is selected as the cache entry to be replaced.

Thus, the cache entry used by the processor in the sleep mode is specified by comparing the executed state values corresponding to the respective cache entries, wherefore the cache entry to be replaced can be easily selected.

In the above shared cache controller, the replacement object selecting section preferably compares the reference time data of the respective plurality of cache entries generated by the reference time data generating section and selects the cache entry corresponding to the reference time data with the maximum reference time count value as the cache entry to be replaced when the executed state values included in the reference time data are all the same.

According to this construction, the reference time data of the respective plurality of cache entries are compared and the cache entry corresponding to the reference time data with the maximum reference time count value is selected as the cache entry to be replaced when the executed state values included in the reference time data are all the same.

Thus, even if the executed states of the respective processors using the plurality of cache entries are same, the cache entry to be replaced is selected based on the reference times of the cache entries. Therefore, the cache entry to be replaced can be more reliably selected.

In the above shared cache controller, it is preferable that each cache entry includes an operating system identifier for identifying the operating system using the cache entry, a reference time count value which is counted according to reference time, at which the cache entry is referred, and increases as the reference time becomes older, and data; that the cache entry setting section includes an executed state storage for storing the executed states of the operating systems and unused time additional values indicating values to be added to the reference time count values according to the executed states, and a reference time data generating section for generating reference time data including the reference time count value for each of the plurality of cache entries by adding the unused time additional value corresponding to the executed state of the operating system using the cache entry to the reference time count value included in the cache entry; and that the replacement object selecting section selects the cache entry corresponding to the maximum one of a plurality of reference time count values included in a plurality of reference time data generated by the reference time data generating section as the cache entry to be replaced.

According to this construction, each cache entry includes the operating system identifier for identifying the operating system using the cache entry, the reference time count value that is counted according to the reference time, at which the cache entry is referred, and increases as the reference time becomes older, and the data. The executed state storage stores the executed states of the operating systems and the unused time additional values indicating the values to be added to the reference time count values according to the executed states. Then, the reference time data including the reference time count value is generated for each of the plurality of the cache entries by adding the unused time additional value corresponding to the executed state of the operating system using the cache entry to the reference time count value included in the cache entry and. Thereafter, the cache entry corresponding to the maximum one of the plurality of reference time count values included in the plurality of generated reference time data is selected as the cache entry to be replaced.

Thus, the cache entry to be replaced is selected according to the executed state of the operating system using the cache entry and the reference time of the cache entry, wherefore the cache entry with the least possibility of use can be selected.

In the above shared cache controller, it is preferable that each cache entry includes a processor identifier for identifying the processor using the cache entry, a reference time count value which is counted according to reference time, at which the cache entry is referred, and increases as the reference time becomes older, and data; that the cache entry setting section includes an executed state storage for storing the executed states of the processors and unused time additional values indicating values to be added to the reference time count values according to the executed states, and a reference time data generating section for generating reference time data including the reference time count value for each of the plurality of cache entries by adding the unused time additional value corresponding to the executed state of the processor using the cache entry to the reference time count value included in the cache entry; and that the replacement object selecting section selects the cache entry corresponding to the maximum one of a plurality of reference time count values included in a plurality of reference time data generated by the reference time data generating section as the cache entry to be replaced.

According to this construction, each cache entry includes the processor identifier for identifying the processor using the cache entry, the reference time count value that is counted according to the reference time, at which the cache entry is referred, and increases as the reference time becomes older, and the data. The executed state storage stores the executed states of the processors and the unused time additional values indicating the values to be added to the reference time count values according to the executed states. Then, the reference time data including the reference time count value is generated for each of the plurality of the cache entries by adding the unused time additional value corresponding to the executed state of the processor using the cache entry to the reference time count value included in the cache entry. Thereafter, the cache entry corresponding to the maximum one of the plurality of reference time count values included in the plurality of generated reference time data is selected as the cache entry to be replaced.

Thus, the cache entry to be replaced is selected according to the executed state of the processor using the cache entry and the reference time of the cache entry, wherefore the cache entry with the least possibility of use can be selected.

In the above shared cache controller, it is preferable that the power control command includes at least one of a power supply control command for reducing the power supplied to the processor and a clock control command for reducing clocks supplied to the processor; that the executed state further includes a low power consumption mode which operates with a low speed clock; and that the unused time additional value corresponding to the sleep mode is larger than that corresponding to the low power consumption mode.

According to this construction, the power control command includes at least one of the power supply control command for reducing the power supplied to the processor and the clock control command for reducing clocks supplied to the processor, and the executed state further includes the low power consumption mode which operates with a low speed clock. Since the unused time additional value corresponding to the sleep mode is larger than that corresponding to the low power consumption mode, the cache entry used by the operating system or the processor in the sleep mode can be preferentially selected as a replacement object over the cache entry used by the operating system or the processor in the low power consumption mode.

In the above shared cache controller, the unused time additional value corresponding to the low power consumption mode is preferably larger than that corresponding to the normal operation mode and smaller than that corresponding to the sleep mode.

According to this construction, since the unused time additional value corresponding to the low power consumption mode is larger than that corresponding to the normal operation mode and smaller than that corresponding to the sleep mode, the cache entry used by the operating system or the processor in the low power consumption mode can be preferentially selected as a replacement object over the cache entry used by the operating system or the processor in the normal operation mode.

In the above shared cache controller, it is preferable that the power control command includes at least a sleep command for instructing the operation stop of the operating system; that the executed state includes at least a normal operation mode in which the operating system is operated with a high speed clock and a sleep mode in which the operation of the operating system is stopped; the cache storage device includes a plurality of ways each including the plurality of cache entries; that the cache entry setting section includes an executed state storage for storing the executed states of the plurality of operating systems that are changed based on the power control command and way identifiers for identifying the ways used by the operating systems out of the plurality of ways, and a lock down controlling section for referring to the executed state storage, setting the way used by the operating system in the sleep mode as the way to be replaced and setting the way used by the operating system in the normal operation mode as the way not to be replaced; and that the replacement object selecting section selects the least recently used cache entry out of the ways set as those to be replaced by the lock down controlling section as the cache entry to be replaced.

According to this construction, the power control command includes at least the sleep command for instructing the operation stop of the operating system, the executed state includes at least the normal operation mode in which the operating system is operated with a high speed clock and the sleep mode in which the operation of the operating system is stopped and the cache storage device includes the plurality of ways each including the plurality of cache entries. The executed state storage stores the executed states of the plurality of operating systems that are changed based on the power control command and the way identifiers for identifying the ways used by the operating systems out of the plurality of ways. The executed state storage is referred to, the way used by the operating system in the sleep mode is set as the way to be replaced and the way used by the operating system in the normal operation mode is set as the way not to be replaced. Thereafter, the least recently used cache entry out of the ways set as those to be replaced is selected as the cache entry to be replaced.

Thus, the way used by the operating system in the sleep mode is set as the way to be replaced and the way used by the operating system in the normal operation mode is set as the way not to be replaced. Therefore, the operating system in the normal operation mode can use the cache entry used by the operating system in the sleep mode and the cache storage device can be effectively utilized according to the executed states of the operating systems without mounting the operating system identifiers in the cache entries.

### INDUSTRIAL APPLICABILITY

The shared cache controller, share cache control method and integrated circuit according to the present invention enable one cache storage device to be effectively utilized by a plurality of operating systems or a plurality of processors and are useful for embedded system LSIs of mobile phones, information appliances and the like equipped with a plurality of processor cores or a plurality of operating systems. Besides the embedded system LSIs, they are effectively applied for computer systems in which a cache storage device is shared by a plurality of processor cores or a plurality of operating systems.

1-28. (canceled)

29. A shared cache controller for selecting a cache entry to be replaced from among a plurality of cache entries shared by a plurality of operating systems or a plurality of processors, and for storing data read from a main storage,
wherein:
the shared cache controller manages an identifier for identifying the plurality of operating systems or the plurality of processors referring to the cache entry, reference information relating to the order of the cache entry referred to by the plurality of operating systems or the plurality of processors, and executed state information relating to executed states of the plurality of operating systems or the plurality of processors in correlation with each other.

30. The shared cache controller according to claim 29, further comprising:
a cache entry setting section for setting a cache entry used by the operating system or the processor whose executed state has been changed, as a cache entry referred to in the past; and
a replacement object selecting section for selecting the cache entry set as the cache entry referred to in the past, as a cache entry to be replaced.

31. The shared cache controller according to claim 30, wherein:
the executed state is changed by executing a power control command for controller electric power to be supplied to a processor which operates the plurality of operating systems, or the plurality of processors.

32. The shared cache controller according to claim 31, wherein:
the power control command includes at least a sleep command for instructing the operation stop of the operating system;
the executed state includes at least a normal operation mode in which the operating system is operated with a high speed clock and a sleep mode in which the operation of the operating system is stopped by the sleep command;
the cache entry setting section sets the cache entry used by the operating system in the sleep mode as a cache entry referred to in the past older than the cache entry used by the operating system in the normal operation mode; and
the replacement object selecting section selects the cache entry set to be the least recently referred cache entry as the cache entry to be replaced.

33. The shared cache controller according to claim 32, wherein:
each cache entry includes an operating system identifier being the identifier and for identifying the operating system using the cache entry, a reference time count value being the reference information, and which is counted according to reference time, at which the cache entry is referred, and increases as the reference time becomes older, and data;
the cache entry setting section includes an executed state storage for storing the executed states of the plurality of operating systems that are changed based on the power control command, and executed state values being the executed state information and which are set beforehand according to the executed states and are larger when corresponding to the sleep mode than when corresponding to the normal operation mode, and a reference time data generating section for generating reference time data including the executed state value and the reference time count value for each of the plurality of cache entries; and
the replacement object selecting section compares the reference time data of the respective plurality of cache entries generated by the reference time data generating section and selects the cache entry corresponding to the reference time data with the maximum executed state value as the cache entry to be replaced.

34. The shared cache controller according to claim 33, wherein the replacement object selecting section compares the reference time data of the respective plurality of cache entries generated by the reference time data generating section and selects the cache entry corresponding to the reference time data with the maximum reference time count value as the cache entry to be replaced when the executed state values included in the reference time data are all the same.

35. The shared cache controller according to claim 31, wherein:
the power control command includes at least a sleep command for instructing an operation stop of the processor;
the executed state includes a normal operation mode in which the processor is operated with a high speed clock and a sleep mode in which the operation of the processor is stopped by the sleep command;
the cache entry setting section sets the cache entry used by the processor in the sleep mode as a cache entry referred to in the past older than the cache entry used by the processor in the normal operation mode; and
the replacement object selecting section selects the cache entry set to be the least recently referred cache entry as the cache entry to be replaced.

36. The shared cache controller according to claim 35, wherein:
each cache entry includes a processor identifier being the identifier and for identifying the processor using the cache entry and a reference time count value being the reference information and which is counted according to reference time, at which the cache entry is referred, and increases as the reference time becomes older, and data;
the cache entry setting section includes an executed state storage for storing the executed states of the plurality of processors that are changed based on the power control command, and executed state values being the executed state information and which are set beforehand according to the executed states and are larger when corresponding to the sleep mode than when corresponding to the normal operation mode, and a reference time data generating section for generating reference time data including the executed state value and the reference time count value for each of the plurality of cache entries; and
the replacement object selecting section compares the reference time data of the respective plurality of cache entries generated by the reference time data generating section and selects the cache entry corresponding to the reference time data with the maximum executed state value as the cache entry to be replaced.

37. The shared cache controller according to claim 36, wherein the replacement object selecting section compares the reference time data of the respective plurality of cache entries generated by the reference time data generating section and selects the cache entry corresponding to the reference time data with the maximum reference time count value as the cache entry to be replaced when the executed state values included in the reference time data are all the same.

38. The shared cache controller according to claim 32, wherein:
each cache entry includes an operating system identifier being the identifier and for identifying the operating system using the cache entry, a reference time count value being the reference information and which is counted according to reference time, at which the cache entry is referred, and increases as the reference time becomes older, and data;
the cache entry setting section includes an executed state storage for storing the executed states of the operating systems, and unused time additional values being the executed state information and indicating values to be added to the reference time count values according to the executed states, and a reference time data generating section for generating reference time data including the reference time count value for each of the plurality of cache entries by adding the unused time additional value corresponding to the executed state of the operating system using the cache entry to the reference time count value included in the cache entry; and
the replacement object selecting section selects the cache entry corresponding to the maximum one of a plurality of reference time count values included in a plurality of reference time data generated by the reference time data generating section as the cache entry to be replaced.

39. The shared cache controller according to claim 35, wherein:
each cache entry includes a processor identifier being the identifier and for identifying the processor using the cache entry, a reference time count value being the reference information and which is counted according to reference time, at which the cache entry is referred, and increases as the reference time becomes older, and data;
the cache entry setting section includes an executed state storage for storing the executed states of the processors, and unused time additional values indicating values being the executed state information and to be added to the reference time count values according to the executed states, and a reference time data generating section for generating reference time data including the reference time count value for each of the plurality of cache entries by adding the unused time additional value corresponding to the executed state of the processor using the cache entry to the reference time count value included in the cache entry; and
the replacement object selecting section selects the cache entry corresponding to the maximum one of a plurality of reference time count values included in a plurality of reference time data generated by the reference time data generating section as the cache entry to be replaced.

40. The shared cache controller according to claim 38, wherein:
the power control command includes at least one of a power supply control command for reducing the power supplied to the processor and a clock control command for reducing clocks supplied to the processor;
the executed state further includes a low power consumption mode which operates with a low speed clock by the clock control command; and
the unused time additional value corresponding to the sleep mode is larger than that corresponding to the low power consumption mode.

41. The shared cache controller according to claim 40, wherein the unused time additional value corresponding to the low power consumption mode is larger than that corresponding to the normal operation mode and smaller than that corresponding to the sleep mode.

42. The shared cache controller according to claim 30, wherein:
the executed state is changed by occurrence of an interrupt.

43. A shared cache controller for selecting a cache entry to be replaced from among a plurality of cache entries shared by a plurality of operating systems or a plurality of processors, and for storing data read from a main storage, comprising:
a cache entry setting section for setting a cache entry used by the operating system or the processor whose executed state has been changed, as a cache entry referred to in the past; and
a replacement object selecting section for selecting the cache entry set as the cache entry referred to in the past, as a cache entry to be replaced.

44. A shared cache control method, comprising:
a cache storage step of storing data in a cache storage device which is shared by a plurality of operating systems or a plurality of processors and includes a plurality of cache entries for storing data read from a main storage; and
a managing step of managing an identifier for identifying the operating system or the processor using the cache entry, reference information relating to the order of the referred cache entry, and executed states of the plurality of operating systems in correlation with each other.

45. An integrated circuit for selecting a cache entry to be replaced from among a plurality of cache entries shared by a plurality of operating systems or a plurality of processors, and for storing data read from a main storage
wherein:
the integrated circuit manages an identifier for identifying the operating system or the processor using the cache entry, reference information relating to the order of the referred cache entry, and executed states of the plurality of operating systems in correlation with each other.
